(19) United States
(12) Patent Application Publication
(10) Pub. No.: US 2015/0056337 A1
(43) Pub. Date: Feb. 26, 2015

(54) SYSTEM AND METHOD FOR PRODUCING BREAD PRODUCTS

(71) Applicant: Elwha LLC, Bellevue, WA (US)

(72) Inventors: SAMUEL J. FAHEY-BURKE, SEATTLE, WA (US); NATHAN P. MYHRVOLD, MEDINA, WA (US); HUAN LARISSA ZHOU, SEATTLE, WA (US)

(21) Appl. No.: 13/974,270

(22) Filed: Aug. 23, 2013

(51) Int. Cl. A21D 10/00; A21C 11/16; A21C 11/02; A21D 15/02; A21C 9/06

(52) U.S. Cl. CPC A21D 10/00; A21D 15/02; A21C 9/065; A21C 11/02; A21C 11/16
USPC 426/95; 426/138; 426/94; 426/504; 426/283; 62/440; 99/348

(57) ABSTRACT

An improved system and method for the production of a bread product is disclosed. The method may comprise the steps of (a) mixing a first set of ingredients into a first dough component; (b) forming the first dough component into a dough base in a fixture in a molding operation; (c) forming a distinct cavity in the base with a cavity-forming operation; (d) finishing the bread product. The system may comprise (a) a mixing station for mixing a first set of ingredients into a first dough component; (b) a forming station for forming the first dough component into a dough base having a form and a distinct cavity formed by a cavity-forming operation; and (c) a dough finishing station for finishing the bread product into a finished bread product. The bread product when finished by baking comprises a crumb provided by the dough base and the distinct cavity formed by the cavity-forming operation.

### CROSS-REFERENCE TO RELATED APPLICATIONS

Priority Applications: [None]

Related Applications: (a) U.S. patent application Ser. No. 13/974,256, entitled SYSTEM AND METHOD FOR PRODUCING BREAD PRODUCTS, naming N. Myhrvold, H. Zhou and S. Fahey-Burke as inventors, filed Aug. 23, 2013, with Docket no. 0712-038-001-000000, is related to and incorporated by reference in the present application; and (b) U.S. patent application Ser. No. 13/974,283, entitled SYSTEM AND METHOD FOR THE MANUFACTURE OF PIZZA PRODUCTS, naming N. Myhrvold, A. Chan, H. Zhou and S. Fahey-Burke as inventors, filed Aug. 23, 2013, with Docket no. 0712-038-003-000000, is related to and incorporated by reference in the present application.

### FIELD

The present invention relates to a system and method for producing bread products. The present invention also relates to bread products that can be manufactured with the system and method.

### BACKGROUND

It is well known to produce a bread product from a dough component. A common bread product has a dough component mixed from ingredients (such as flour, water, salt, etc.) and formed into a dough base that is then finished by baking into a baked bread product ready for use and consumption. Formulations of ingredients for the dough component and operating conditions for baking (e.g. temperature, time, humidity, air movement, etc.) can be selected to produce a wide variety of textures, flavors and other characteristics and effects in the bread product.

Bread products are made in a wide variety of types and forms and shapes and sizes. A typical bread product may be produced in a generally known range of forms and shapes and sizes, including the common variations of the bread loaf. The readily available range of sizes and shapes and forms of a bread product is to some extent constrained due to limitations of the dough component and the desire for uniformity and evenness (among other objectives) in the resultant baked bread product from the finishing or baking process.

In the baked bread product, the interior dough mass forms the crumb and the exterior surface of the dough mass forms the crust. A typical bread product has a crumb that is a monolithic form providing a generally monolithic density as a result of the typical forming operation (and of the bread product being comprised of one dough component). The crumb of a typical bread product may possibly have many small voids that form within the crumb during leavening and baking but will not have by design any distinct cavity or open space. It is known that the size and density of the voids in the crumb and may be affected by adjustments of the formulation of the dough product (for example, the amount of water relative to flour in the ingredient mix).

It is known that air or gas can be injected into a dough component (and that the dough mass may be able to “inflate” to some degree). For example, an alveograph injects air into a dough mass to test (among other things) the extensibility of a particular dough formulation. However, it is not well-known to produce a bread product with a distinct air-injected cavity. Bread products that may be sold with a distinct cavity (such as bread bowls) are not typically formed and finished in production with a distinct open cavity (notwithstanding that air pockets may form in a bread product during the finishing/baking process). It is better known that hollowed-out bread products such as bread bowls are produced by forming/baking a typical form of bread loaf without a cavity and then cutting and removing a portion of the interior crumb to create a cavity (e.g. by hand in a manual operation after finishing rather than by a cavity-forming operation in production).

It is also not well-known or common in commercial production to provide a multi-component bread product made with a base formed of one dough component and an interior section formed from a separate dough component (e.g. a dough component fill as would occupy a cavity in the bread product). The typical commercial bread product is made from a single dough component. It is also known to produce foodstuffs such as confection products that contain a fill material (e.g. such as a filled doughnut with a base formed from a dough component and a fill provided through a mixture of a fruit-based or dairy based or other type of non-dough fill); such typical confection products do not contain a dough fill (e.g. a fill material that is a second dough component supplied into the dough base at the forming operation).

It is known to produce foodstuffs such from dough components using fixtures (e.g. pans) having a selected form that is generally given to the resultant product. It is known in commercial production to produce such products as muffins, cakes, pies in pans which provide a designated consistent form to the product. It is also known to produce certain bread products such as sliced bread loaves by high-volume processes in fixtures such as pans that give the products a consistent form provided by a pan. Such high-volume commercial bread products generally exhibit distinctive characteristics in addition to consistency of form that affect the consumer appeal and typically are readily distinguishable from other types of bread products such as artisan breads which tend to exhibit different characteristics (e.g. form, texture, taste, etc.) that some consumers may find more appealing.

It is also well known to mold articles or objects in manufacturing processes from moldable materials such as plastics in high-volume manufacturing processes such as injection molding or blow-molding (e.g. creating open or novel plastic forms such as bottles using blow-molding techniques). It is also known that using such molding techniques a variety of plastic products may be produced in a wide variety of forms, shapes, sizes, and types by using mold fixtures that are designed and assembled to produce each product in the desired design form, shape and size. High-volume commercial manufacturing processes are able to achieve consistency and quality in the form and appearance of such molded plastic products and articles with designs that provide a desired appearance, external aesthetic, etc.

There is identified an opportunity for an improved system and method of producing a bread product to create an attractive and appealing bread product having desired a form, shape, consistency and quality on a high-volume commercial-industrial scale. There is identified an opportunity to use the improved system and method to produce a bread product with an established distinct interior cavity that can remain open/empty or that can be filled with a fill material to form a multi-component bread product (e.g. with a dough component forming a base providing a cavity and another dough component as a fill material within the cavity). The improved system and method can provide a forming operation that allows the bread product to be produced in various pre-selected forms, shapes and sizes in a consistent manner. The improved system and method can provide a finishing operation that facilitates uniformity of cooking or baking to achieve desired characteristics for the resultant baked bread product (e.g. attractive, appealing and tasteful bread product that exhibits other selected desirable characteristics and combinations of characteristics commonly enjoyed by consumers).

### SUMMARY

The present invention relates to a bread product having a pre-selected form finished for commercial distribution. The bread product comprises a dough base formed from a first dough component into the pre-selected form by a molding operation. The bread product has a distinct cavity within the dough base formed by a cavity-forming operation. The first dough component is formulated from a first set of ingredients comprising flour and water. The cavity-forming operation is initiated before the bread product is finished so that the bread product of the pre-selected form with cavity can be formed as a baked bread product.

The present invention also relates to process for producing a bread product. The process comprises the steps of (a) mixing a first set of ingredients into a first dough component; (b) forming the first dough component into a dough base in a fixture in a molding operation; (c) forming a distinct cavity in the base with a cavity-forming operation; (d) finishing the bread product.

The present invention further relates to a system for producing a bread product having a distinct cavity. The system comprises (a) a mixing station for mixing a first set of ingredients into a first dough component; (b) a forming station for forming the first dough component into a dough base having a form and a distinct cavity formed by a cavity-forming operation; and (c) a dough finishing station for finishing the bread product into a finished bread product. The bread product when finished by baking comprises a crumb provided by the dough base and the cavity formed by the cavity forming operation.

The present invention further relates to a multi-component bread product formed by an extrusion process comprising a first dough component and a second dough component. The first dough component is extruded with the second dough component to form an elongated extruded form that can be formed into an extruded multi-component bread product when divided to a desired length. The extruded multi-component bread product can be finished for commercial distribution. The first dough component is formulated from a first set of ingredients comprising an additive for extensibility and to provide adhesion to the second dough component that is formulated from a second set of ingredients.

The summary is illustrative only and is not intended to be in any way limiting. In addition to the illustrative aspects, embodiments, and features described above, further aspects, embodiments, and features will become apparent by reference to the drawings and the following detailed description.

### FIGURES

FIG. 1A is a perspective view of a bread product according to an exemplary embodiment.

FIG. 1B is a cut-away perspective view of a bread product according to an exemplary embodiment.

FIG. 1C is a cross-sectional view of a bread product according to an exemplary embodiment.

FIG. 2A is a perspective view of a bread product according to an exemplary embodiment.

FIG. 2B is a cut-away perspective view of a bread product according to an exemplary embodiment.

FIG. 2C is a cross-sectional view of a bread product according to an exemplary embodiment.

FIG. 3A is a schematic block diagram of a system for producing a bread product according to an exemplary embodiment.

FIG. 3B is a schematic process flow diagram of a system for producing a bread product according to an exemplary embodiment.

FIG. 4 is a schematic process flow diagram of the mixing operation of the system for producing a bread product according to an exemplary embodiment.

FIG. 5 is a schematic process flow diagram of a mixing operation of the system for producing a bread product according to an exemplary embodiment.

FIG. 6 is a schematic process flow diagram of a forming operation of the system for producing a bread product according to an exemplary embodiment.

FIGS. 7A-7F are schematic process flow diagrams of a forming operation of the system for producing bread products according to an exemplary embodiment.

FIG. 7G is a schematic block diagram of a forming station and a control system for the system and method according to an exemplary embodiment.

FIGS. 8A-8B are schematic process flow diagrams of a forming operation of the system for producing bread products according to an exemplary embodiment.

FIGS. 9A-9D are schematic process flow diagrams of a forming operation of the system for producing bread products according to an exemplary embodiment.

FIGS. 10A-10C are schematic process flow diagrams of a finishing operation of the system for producing bread products according to an exemplary embodiment.

FIGS. 11A-11B are schematic process flow diagrams of a finishing operation of the system for producing bread products according to an exemplary embodiment.

FIG. 12 is a schematic process flow diagram of a packing operation of the system for producing a bread product according to an exemplary embodiment.

FIGS. 13A 13D are schematic cross-section views of a system for producing a bread product in operation according to an exemplary embodiment.

FIG. 13E is a perspective view of a bread product of a type produced in the system of FIGS. 13A 13D.

FIG. 14A-14H are schematic cross-section views of a system for producing a bread product in operation according to an exemplary embodiment.

FIG. 14I is a perspective view of a bread product according to an exemplary embodiment.

FIG. 14J is a cut-away perspective view of a bread product according to an exemplary embodiment.

FIGS. 15A-15H are schematic cross-section views of a system for producing a bread product in operation according to an exemplary embodiment.

FIG. 15I is a perspective view of a bread product of a type produced in the system of FIGS. 15A-15H.

FIG. 15J is a cut-away perspective view of a bread product of a type produced in the system of FIGS. 15A-15H.

FIGS. 16A-16H are schematic cross-section views of a system for producing a bread product in operation according to an exemplary embodiment.

FIG. 16I is a perspective view of a bread product of a type produced in the system of FIGS. 16A-16H.

FIG. 16J is a cut-away perspective view of a bread product of a type produced in the system of FIGS. 16A-16H.

FIGS. 17A-17G are schematic cross-section views of a system for producing a bread product in operation according to an exemplary embodiment.

FIG. 17H is a cut-away perspective view of a bread product of a type produced in the system of FIGS. 17A-17G.

FIGS. 18A-18H are schematic cross-section views of a system for producing a bread product in operation according to an exemplary embodiment.

FIGS. 19A-19L are schematic cross-section views of a system for producing a bread product in operation according to an exemplary embodiment.

FIGS. 20A-20E are schematic cross-section views of a system for producing a bread product in operation according to an exemplary embodiment.

FIGS. 21A-21E are schematic cross-section views of a system for producing a bread product in operation according to an exemplary embodiment.

FIGS. 22A-22I are schematic cross-section views of a system for producing a bread product in operation according to an exemplary embodiment.

FIGS. 23A-23G are schematic cross-section views of a system for producing a bread product in operation according to an exemplary embodiment.

FIGS. 24A-24H are schematic cross-section views of a system for producing a bread product in operation according to an exemplary embodiment.

FIGS. 25A-25G are schematic cross-section views of a system for producing a bread product in operation according to an exemplary embodiment.

FIGS. 26A-26I are schematic cross-section views of a system for producing a bread product in operation according to an alternative embodiment.

FIG. 26J is a cut-away perspective view of a bread product of a type produced in the system of FIGS. 26A-26I.

FIGS. 27A-27D are schematic cross-section views of a system for producing a bread product in operation according to an alternative embodiment.

FIGS. 28A-28D are schematic cross-section views of a system for producing a bread product in operation according to an alternative embodiment.

FIGS. 29A-29F are schematic cross-section views of a system for producing a bread product in operation according to an alternative embodiment.

FIG. 29G is a cut-away perspective view of a bread product of a type produced in the system of FIGS. 29A-29F.

FIG. 29H is a cut-away perspective view of a bread product of a type produced in the system of FIGS. 29A-29F.

FIGS. 30A-30F are schematic cross-section views of a system for producing a bread product in operation according to an alternative embodiment.

FIG. 30G is a cut-away perspective view of a bread product of a type produced in the system of FIGS. 30A-30F.

FIG. 31 is a schematic perspective view of a fixture for producing a bread product according to an exemplary embodiment.

FIGS. 32A 32B are schematic partial perspective views of a fixture for producing a bread product according to an alternative embodiment.

FIGS. 33A-33D are schematic cross-section views of a system for producing a bread product in operation according to an exemplary embodiment.

FIG. 33E is a top view of a bread product of a type produced in the system of FIGS. 33A 33D.

FIGS. 34A-34D are schematic cross-section views of a system for producing a bread product in operation according to an exemplary embodiment.

FIG. 34E is a top view of a bread product of a type produced in the system of FIGS. 33A 33D.

FIGS. 35A-35J are schematic cross-section views of a system for producing a bread product in operation according to an exemplary embodiment.

FIG. 35K is a cut-away perspective view of a bread product of a type produced in the system of FIGS. 35A-35J.

FIG. 36 is a schematic cross-section diagram of an extrusion system for producing a bread product according to an exemplary embodiment.

FIG. 37A is a schematic fragmentary cross-section diagram of the extrusion system for producing a bread product according to an exemplary embodiment.

FIG. 37B is a schematic cross-section view of a bread product of a type produced in the system of FIG. 36 according to an alternative embodiment.

FIG. 37C is a perspective view of a bread product according to an alternative embodiment.

FIGS. 38A 38L are schematic cross-section views of bread products of a type produced according to exemplary and alternative embodiments.

FIGS. 39A-39C are schematic cross-section views of a system for producing a bread product in operation according to an alternative embodiment.

FIG. 39D is a top view of a bread product of a type produced in the system of FIGS. 39A 39C.

FIG. 40A is a perspective diagram of a bread product according to an alternative embodiment.

FIGS. 40B-40C are cut-away perspective views of a bread product of a type shown in FIG. 40A according to an alternative embodiment.

FIG. 40D is a schematic partial perspective view of a fixture for producing a bread product of a type shown in FIGS. 40A-40C according to an alternative embodiment.

FIG. 41A is a perspective view of a bread product according to an alternative embodiment.

FIGS. 41B-41C are cut-away perspective views of a bread product of a type shown in FIG. 41A according to an alternative embodiment.

FIG. 41D is a schematic partial perspective view of a fixture for producing a bread product of a type shown in FIGS. 41A-41C according to an alternative embodiment.

FIG. 42A is a perspective view of a bread product according to an alternative embodiment.

FIGS. 42B-42C are cut-away perspective views of a bread product of a type shown in FIG. 42A according to an alternative embodiment.

FIG. 42D is a schematic partial perspective view of a fixture for producing a bread product of a type shown in FIGS. 42A-42C according to an alternative embodiment.

FIGS. 43A-43B are schematic cross-section views of bread products produced according to exemplary and other embodiments.

FIGS. 44 and 45 are schematic perspective views of bread products produced according to exemplary and other embodiments.

FIG. 46A is a schematic perspective view of a bread product produced according to exemplary and other embodiments.

FIG. 46B is a schematic cross-section view of a bread product produced according to exemplary and other embodiments.

FIG. 47 is a schematic perspective view of a bread product produced according to exemplary and other embodiments.

FIGS. 48A-48B are schematic perspective views of bread products produced according to exemplary and other embodiments.

FIGS. 49 and 50 are schematic perspective views of bread products produced according to exemplary and other embodiments.

FIGS. 51A-51F are schematic cross-section views of bread products produced according to exemplary and other embodiments.

### DESCRIPTION

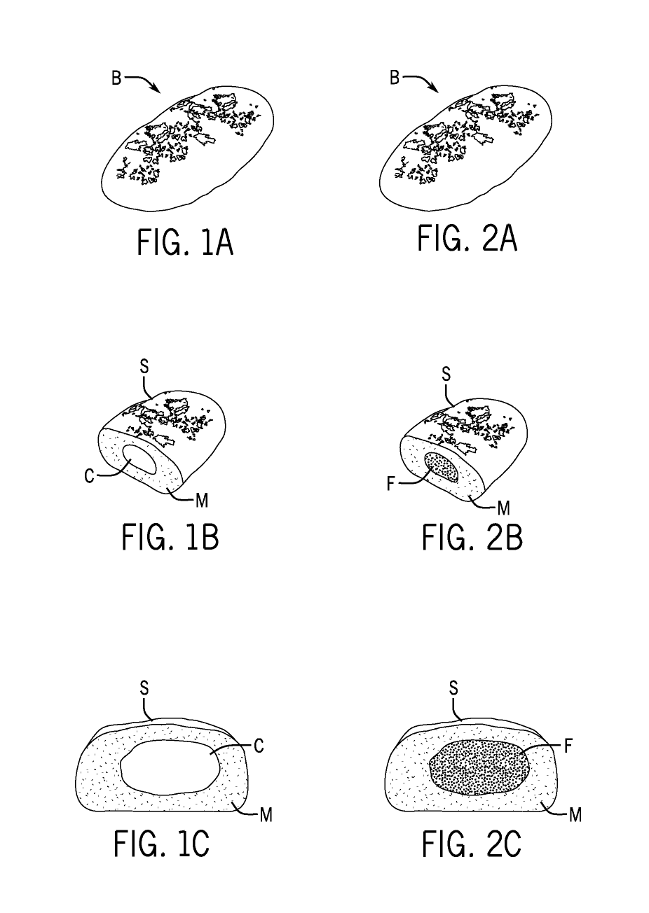

Referring to FIGS. 1A-1C, a bread product B_{C} is shown schematically according to an exemplary embodiment. The bread product B_{C} has a base made from a dough component and is formed by being baked. As indicated in FIGS. 1B and 1C, the baked bread product comprises an exterior layer with a surface shown as crust S and an interior portion shown as crumb M; the bread product B_{C} also comprises a generally central distinct cavity C established within the crumb M. As indicated, the size/volume and configuration/shape of the bread product and the cavity may vary according to exemplary and alternative embodiments of the bread product.

Referring to FIGS. 2A-2C, a bread product B_{F} is shown schematically according to an exemplary embodiment. The bread product B_{F} is made from a substrate or core dough component providing a dough base and a fill component. When baked, the bread product comprises an exterior layer shown as crust S and a multi-component interior portion shown as crumb M and fill F. As indicated in FIGS. 2B and 2C, according to an exemplary embodiment, the fill component is also a dough component and the bread product B_{F} comprises a multi-component bread product. As indicated, the type and relative size/volume of each dough component and therefore the configuration/shape of the entire bread product and relative size/shape of the fill material relative to the dough base may vary according to exemplary and alternative embodiments of the bread product.

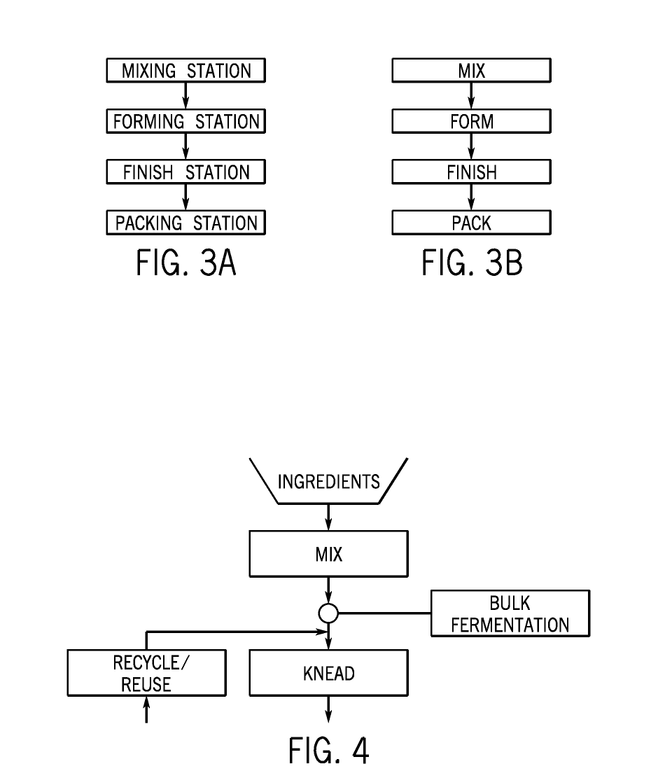

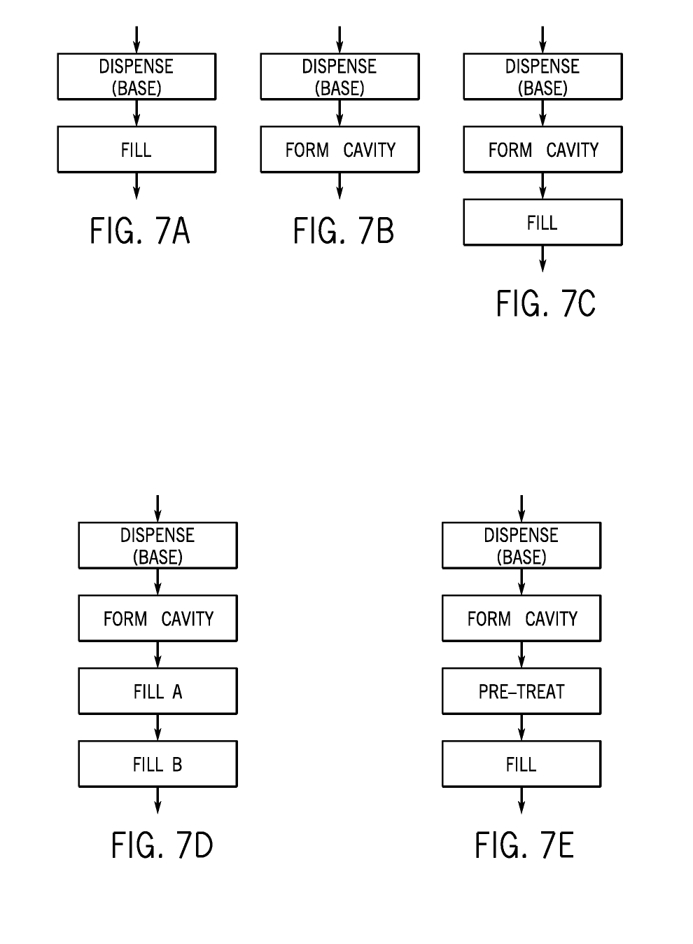

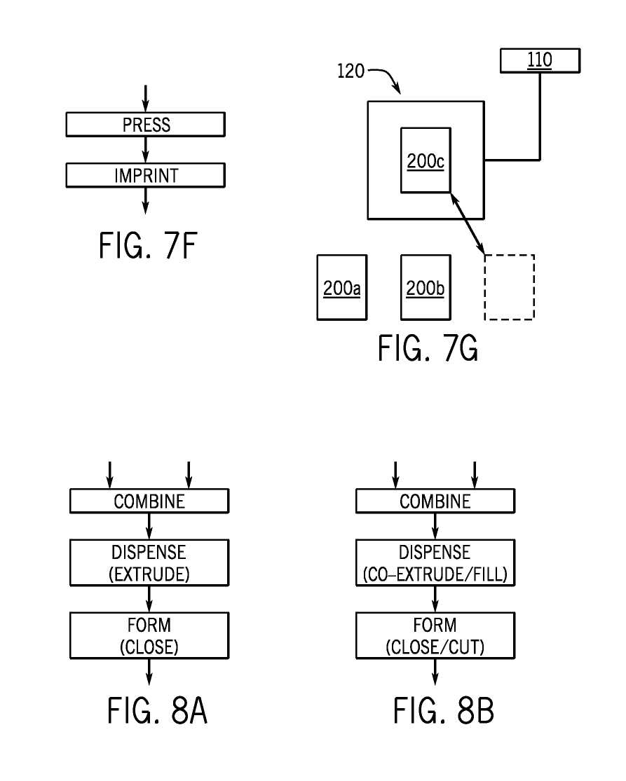

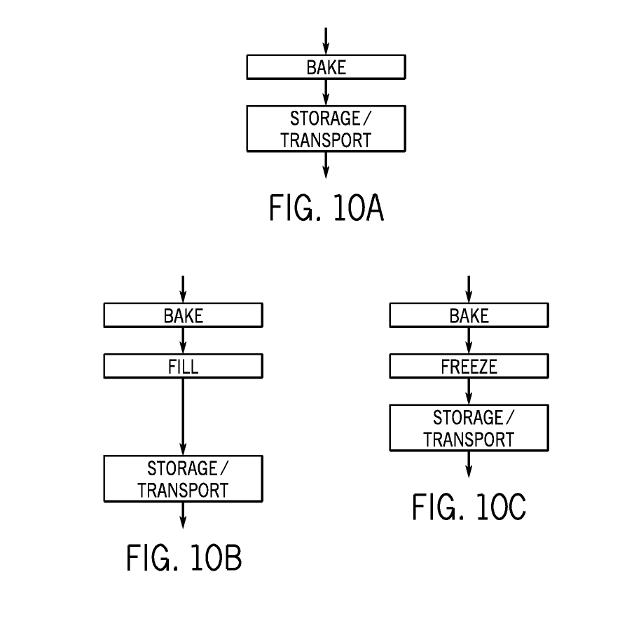

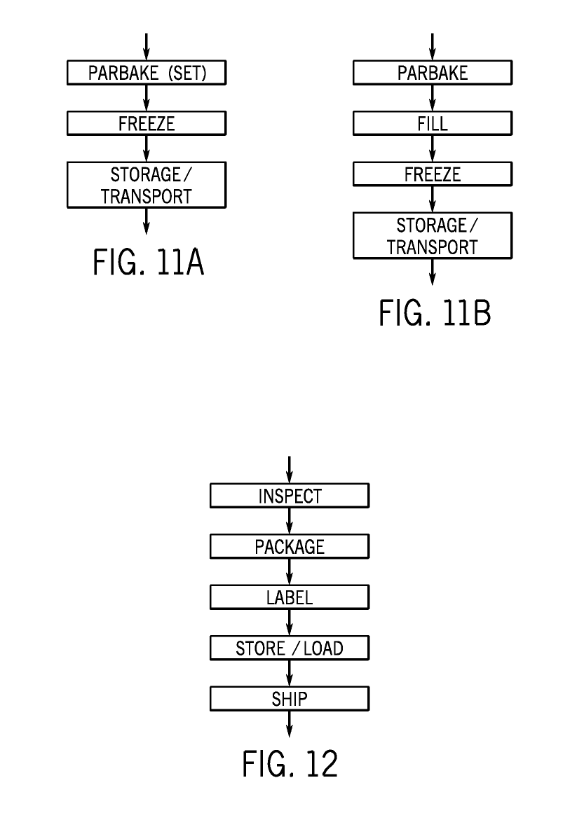

A system and method for producing bread products of a type shown in FIGS. 1A-1C (bread product BC with cavity) and FIGS. 2A-2C (multi-component bread product BF with fill) according to an exemplary embodiment is shown in FIGS. 3A (system) and 3B (method). The system and method comprises a set of stations to perform process steps and operations: ingredients for the components are mixed at a mixing station (see FIG. 4); the dough component of the bread product with cavity (see FIG. 1C) and/or fill with component (see FIG. 2C) is formed at a forming station (see FIGS. 6 to 9D); the bread product is finished (e.g. by baking) at a finish station (e.g. comprising a baking oven or the like, see FIGS. 10A to 11B); the finished bread product is prepared, packed and/or packaged for commercial distribution, shipment, transport, sale, consumption, use, etc. at a packing station (see FIG. 12). At a production facility for the bread product, each station or operation may be programmed, directed, controlled and/or monitored by a control system (e.g. a computer-based or programmable control unit or the like) and connected to a network (such as a LAN with data links, storage) (see, e.g., control system 110 in FIG. 7G).

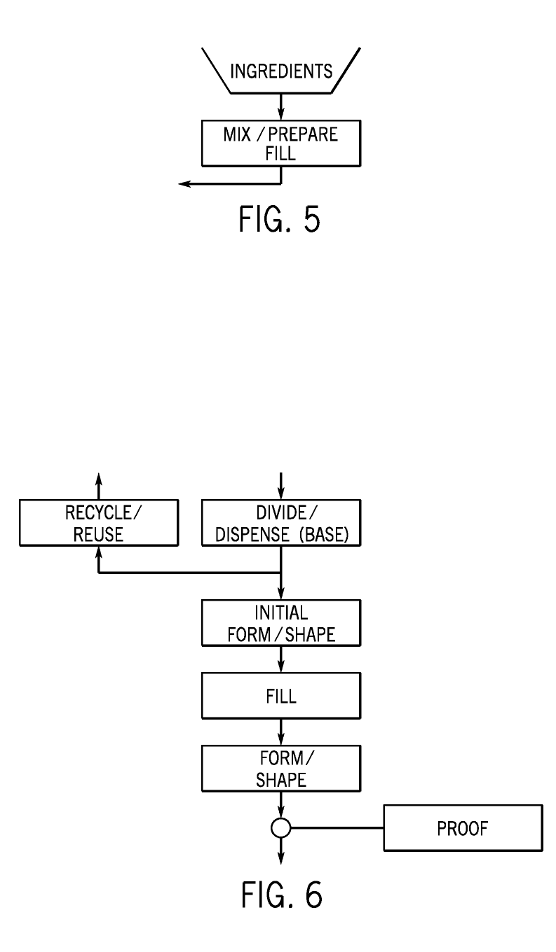

An exemplary embodiment of the mixing process for a dough component of the bread product is shown schematically in FIG. 4. Ingredients for the dough component (e.g. flour, water, other ingredients, etc. to suit the intended recipe or formulation) are mixed and (optionally allowed time for bulk fermentation/proofing) then worked (e.g. by conventional methods such as kneading) into condition for the next station/process operation of forming. As indicated, portions of the dough component remaining from subsequent process operations or stations may be recovered and recycled/reused by recombination with the dough component newly mixed from ingredients. The fill component (if any) can be mixed from ingredients and prepared for dispensing at the forming station, as indicated in FIG. 5.

Exemplary embodiments of the forming process for the dough component of the bread product are shown in FIGS. 6 to 9D. As indicated in FIG. 6, the dough component for the base of the bread product may (after mixing and working) be dispensed and then formed/shaped initially; as indicated, the bread product may be formed with a cavity and/or with fill component. As indicated, the forming process may include suitable adaptations of any of a wide variety of production operations that may be for forming a product from a plastic (dough-like) material (e.g. such as by a blow-molding operation or injection molding operation or other molding operation). The product may be formed without a cavity but in condition to facilitate subsequent processing including forming and/or filling of a cavity; after the cavity is formed and/or filled (e.g. with a fill component such as a dough component for the fill material) the bread product may be completed to form and shaped for subsequent final processing during formation (and/or optionally prior to finishing the product may be allowed time to rise for leavening through proofing). After the formation operation the product is ready for the finishing operation (e.g. including baking of the bread product into a baked bread product).

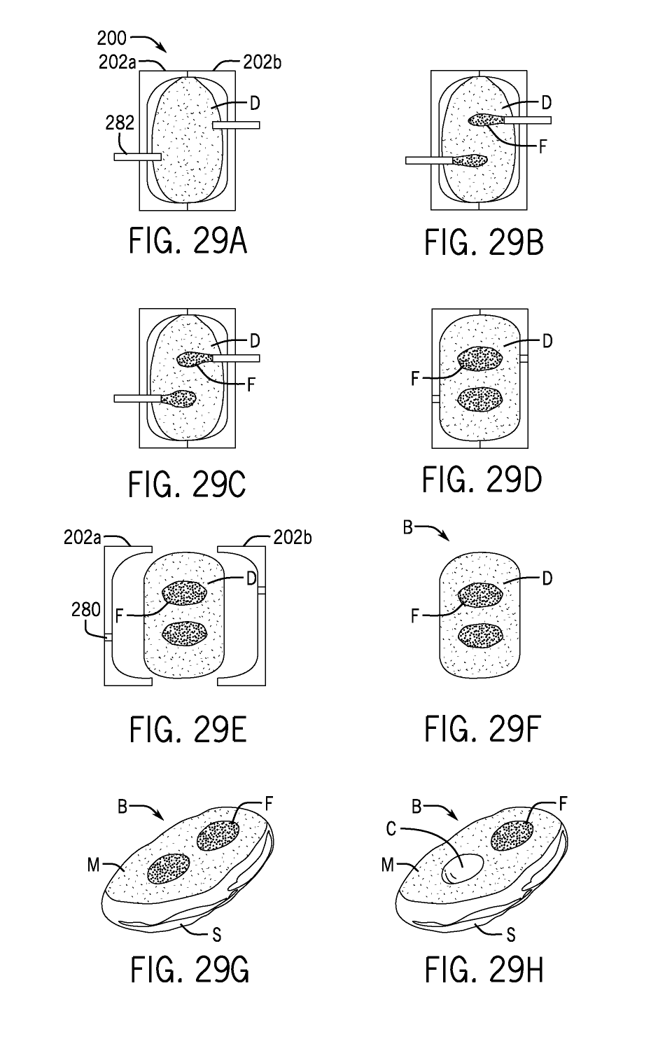

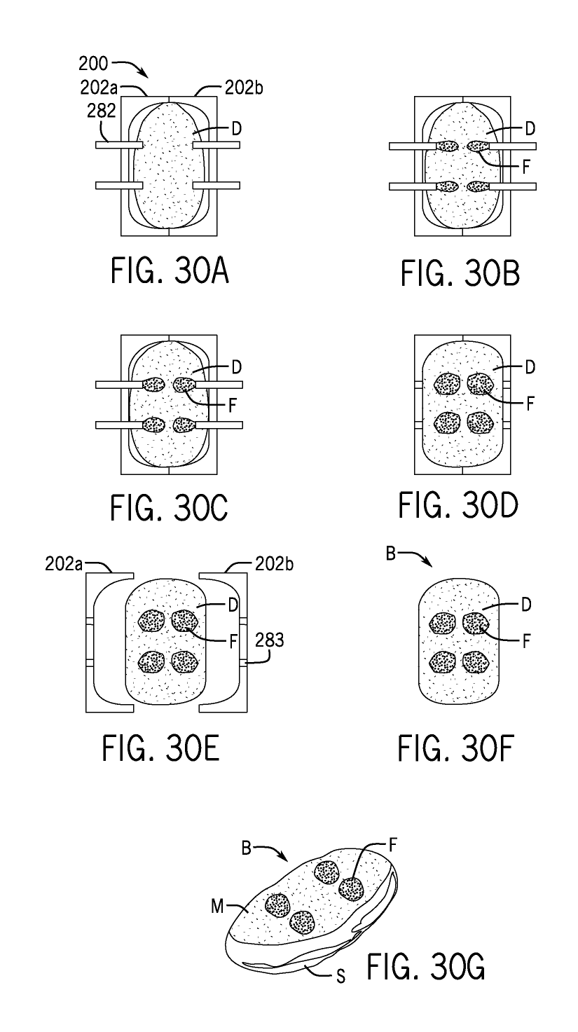

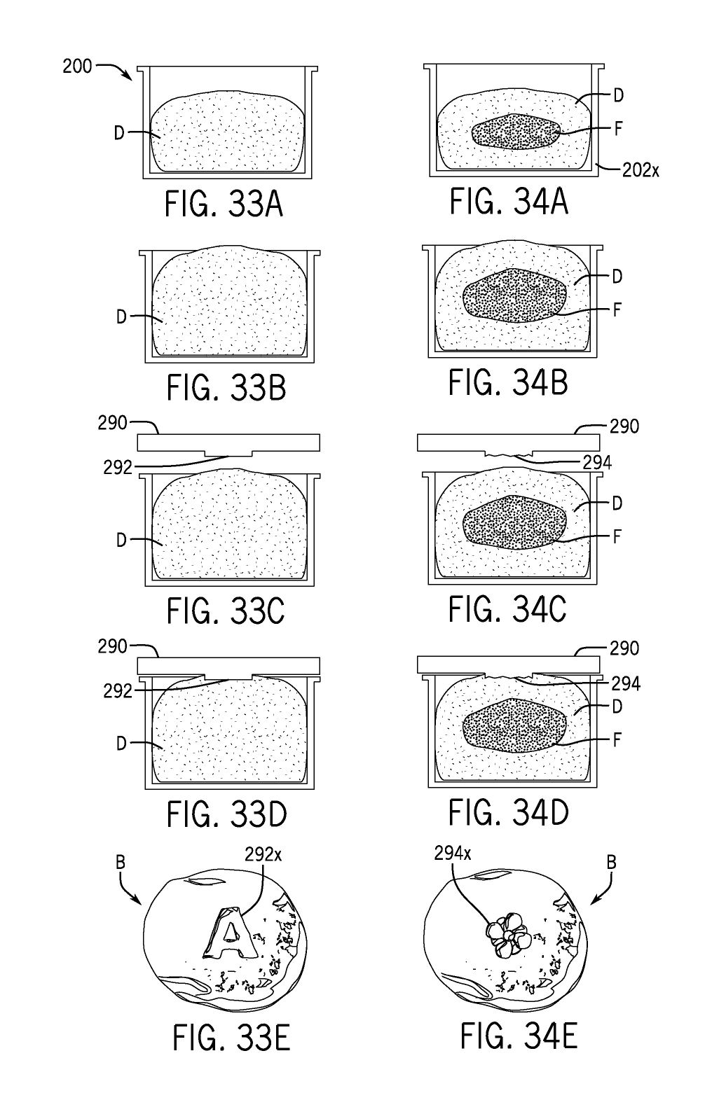

As shown in FIGS. 7A-7F and 8A-8B, the forming operation may comprise various steps and combinations of steps in various sequences according to exemplary and other alternative embodiments. For example, a bread product with a cavity can be formed initially as the base dough component is dispensed (and then optionally filled with a fill component) (see, e.g., FIGS. 6 and 14A-14J or 15A-15J); after the base dough component of the bread product has been dispensed, the fill component may be supplied directly (e.g. injected under pressure) to the form a multi-component bread product with a filled cavity (see FIGS. 2C and 7A); a cavity may be formed in the dough base to form a bread product with cavity (see FIGS. 1B and 7B); a cavity may be formed and then filled with a fill component to form a multi-component bread product with a filled cavity (FIG. 7C); a cavity may be formed and then filled with a first fill component and a second fill component to form a multi-component bread product (FIG. 7D); a cavity may be formed and then pre-treated (e.g. by application of heat or with an additive or ingredient to produce a desired effect such as a “set” to and within the cavity) and then (optionally) filled with a fill component (FIG. 7E). The forming process may according to an alternative embodiment include the formation of multiple cavities and/or fill segments within the dough base of the bread product (see, e.g., FIGS. 29A-29G and 30A-30G) or may include variations in the sequence of steps or operations to dispense the dough component and to form and/or optionally to fill at least one cavity in the bread product. As shown in FIG. 7F, according to an alternative embodiment, the dough component may be pressed (in a tool or fixture) for application of an imprint to provide a desired visual or aesthetic effect in the surface of the bread product (see, e.g., FIGS. 33E and 34E). As indicated, according to other exemplary and alternative embodiments, there may be a wide variety of adjustments and adaptations to the forming process for the bread product.

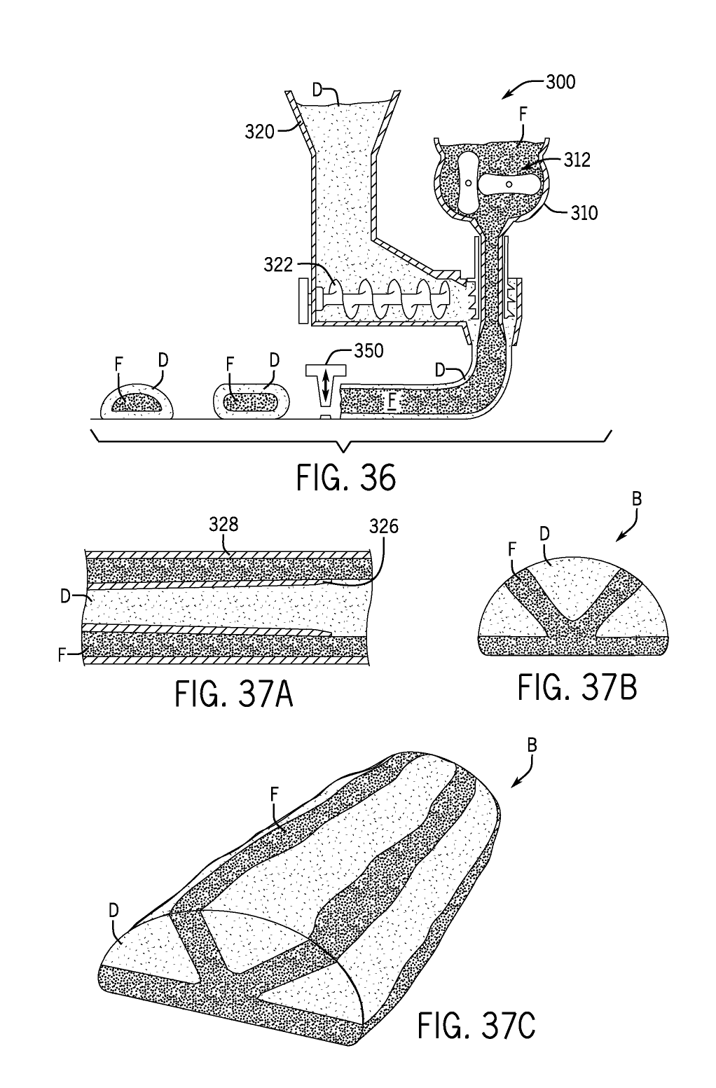

According to other exemplary embodiments as indicated in FIGS. 8A and 8B, a multi-component bread product may be formed by an extrusion process combing streams of separately dispensed dough components such as for a generally center (interior/inner) portion and exterior (outer) portion to form the bread product (see FIG. 8A) or by a co-extrusion process where streams of separate dough components are combined and dispensed together to form the extruded bread product (see FIG. 8B). As indicated, after the dough components have been dispensed through the extrusion/co-extrusion process, the dispensed dough components are formed into a bread product of a desired size and/or shape (e.g. cut and closed into a designated length). As indicated schematically in FIGS. 36, 37A-37C and 38A-38L, other forms of bread products may be created/formed in an extrusion operation.

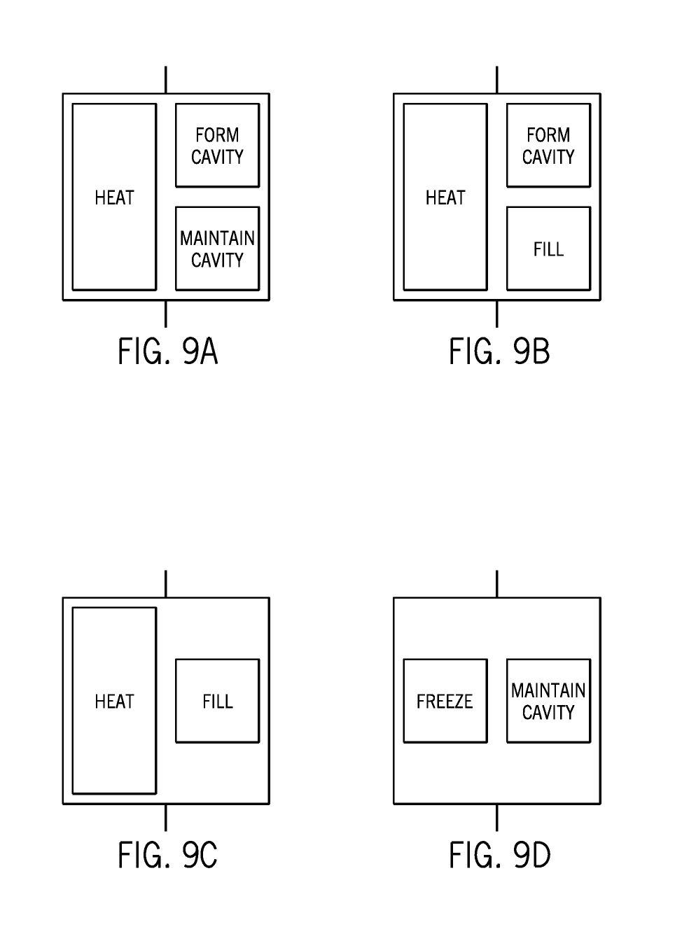

According to other exemplary embodiments shown in FIGS. 9A-9D, the dough component dispensed and formed into the dough base may be heated and/or cooled during the forming/filling operation. The application of heat may facilitate the formation of the cavity by enhancing relevant properties of the dough component (e.g. flow-ability of the dough component into a fixture such as a mold) and/or by causing the cavity to be “set” into the dough component (i.e. gelatinization of the starch in the dough component adjacent to the cavity so that the dough component maintains the form or shape of the cavity after formation, see FIGS. 9A and 9C). The application of cold (e.g. to freeze the dough component at a localized area) may facilitate the maintenance of the cavity after it is formed (e.g. retarding fermentation/leavening or holding a physical form and shape in the dough component). As indicated, heat or cold can be selectively applied at a designated time for the intended purpose and/or according to a control program and/or generally for thermal control to enhance the workability or state of the dough component at the desired step of the cavity formation (see FIGS. 9A and 9D); heat or cold may also be applied in a cycle or according to a control program that may periodically or continuously monitor or control the workability of the fill component at the step of filling or to “set” and maintain the form of the cavity (see FIGS. 9B and 9D).

As indicated in FIGS. 6 to 9D, according to an exemplary embodiment, the forming station may comprise an apparatus that allows the use of a set of modular interchangeable fixtures (e.g. mold fixtures) configured to form bread products of various forms, shapes, and sizes. Referring to FIG. 7G, a forming station 120 is shown schematically according to an exemplary embodiment to comprise an apparatus with modular interchangeable fixtures 200a, 200b and 200c (installed) each configured to form a pre-selected bread product. A wide variety of different fixtures may be designed/built and installed/used to produce a wide variety of different bread products in the forming station. The forming station can be configured and then reconfigured as needed by selection and installation of a fixture designed to produce each of a wide variety of pre-selected forms of bread products. The forming station can be configured so that fixtures can quickly and easily be interchanged as to allow multiple different bread products to be made at one production facility. According to an exemplary embodiment, fixtures for the forming station/apparatus can be designed for each of the types of bread products intended to be produced at the production facility. As shown, forming station 120 is connected to a control system 110 configured to operate a control program for the formation of each pre-selected bread product (e.g. including the cavity-forming operation). According to an exemplary embodiment, control system 110 is coupled to a network through an interface and can communicate with and/or operate other stations in the system (see FIG. 3A) to perform the steps of the method (see FIG. 3B) according to a control program to manage the operating conditions for the bread product in production.

As shown in FIGS. 10A-10C and 11A-11B, according to exemplary embodiments, a finished bread product for use, sale and/or consumption can be produced after the dough component (single or multi-component) has been formed. According to an exemplary embodiment, the formed bread product will be finished by baking (e.g. under designated operating conditions such as temperature, time, humidity, air movement, etc. and/or after allowing time for proofing) and then stored or transported as the baked bread product (e.g. a baked bread loaf) as intended for commercial distribution, sale, and consumption (see FIG. 10A). According to other exemplary embodiments, finishing the bread product may comprise other steps or combinations and sequences of steps. For example, the bread product may be baked and then filled and stored and/or transported for the next operation or use (see FIG. 10B), baked and frozen for storage/transport (see FIG. 10C), par-baked (e.g. set into form) and frozen for storage/transport and subsequent use (see FIG. 11A), par-baked (e.g. set into form) and filled with a fill component and then frozen for storage/transport and subsequent use (see FIG. 11B). As indicated, according to exemplary embodiments, the finished bread product may be a frozen product intended for subsequent baking into a baked bread product at a later time by a customer or another person or entity; the finished bread product may be a baked bread product ready and included for use and consumption; or the finished bread product may be a variation of product (e.g. ready to bake) or other type of product as desired or as required for the intended purpose. According to an exemplary embodiment, some or all of the finishing operations may be performed with the bread product in a fixture used in the forming operation.

Referring to FIG. 12, according to an exemplary embodiment, the final/finished bread product can be completed for commercial distribution, sale and use by further operations at a finishing station. Finishing operations may comprise inspection (e.g. visual, mass properties, x-ray, photographic, etc.) in an attempt to identify defects of any kind, packaging and labeling, storage and loading for transport and shipment or delivery to the intended user or outlet. As indicated, the steps to prepare or complete the bread product for commercial distribution may vary with the type of product and the desired characteristics of the product, the dough component of the product, and/or aspects of the intended use or uses of the product (including, for example, the proximity of the end customer to the production facility). According to one exemplary embodiment, the system can be implemented at a commercial/institutional or retail facility such as a supermarket/superstore, restaurant, food service facility or cafeteria, institution providing food service, etc. where the finished bread product is sold or served for consumption. According to another exemplary embodiment, the system can be implemented at a facility such as a production plant or facility and the finished bread product can in preparation for commercial distribution be packaged and shipped to a commercial/institutional or retail facility for sale and use.

According to exemplary and other embodiments, the system and method can be adapted (in whole or in part or parts) to be incorporated in improvements of any of a wide variety of known/conventional and other production systems and methods currently in use in the production of bread products. For example, apparatus of the system and method (e.g. including any fixture/tool or station as shown in the FIGURES) may be adapted and/or installed and included in improvements of existing/in-use or future-developed systems and methods of manufacturing bread products so that such bread products may be produced in an improved form and manner (e.g. including any bread product as shown in the FIGURES) according to exemplary and other embodiments. According to an exemplary embodiment, for example, an existing or future system and method for producing bread products may be adapted and modified/improved to include an apparatus to form a cavity or cavities and/or a filled cavity or cavities or to form a variety of different molded bread products.

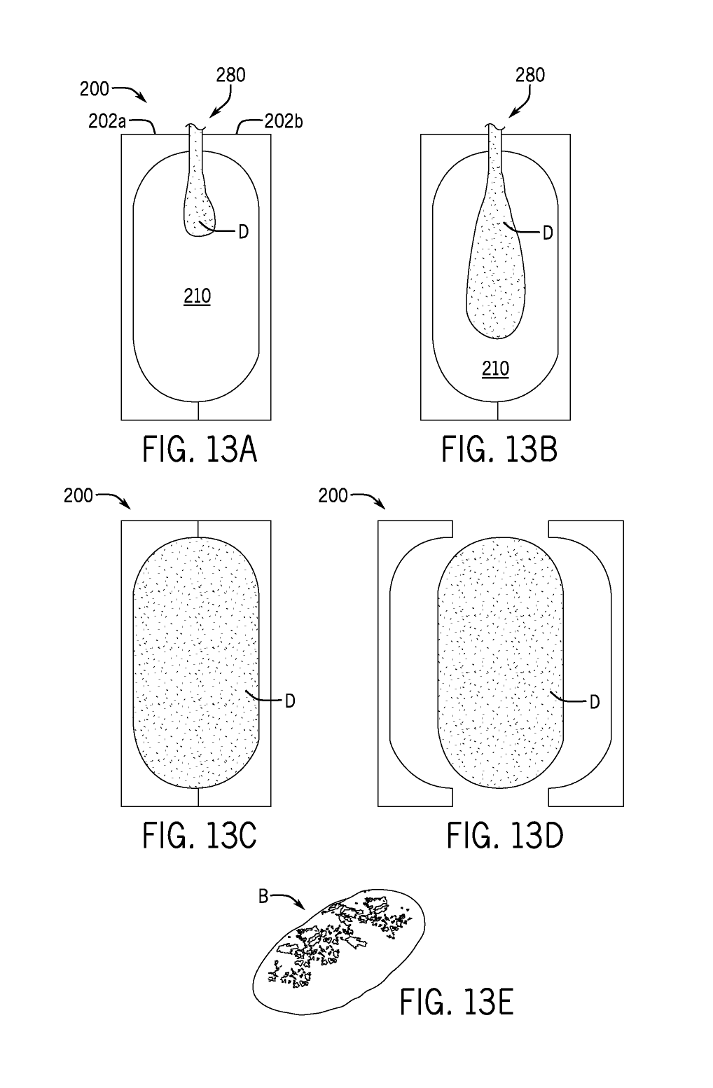

Systems and methods for producing a bread product with an empty cavity and/or filled cavity are shown schematically according to exemplary embodiments in FIGS. 13 through 30. As indicated, the system and method can be implemented using a forming station/apparatus configured to produce bread products in a variety of different forms and types shown schematically in the FIGURES.

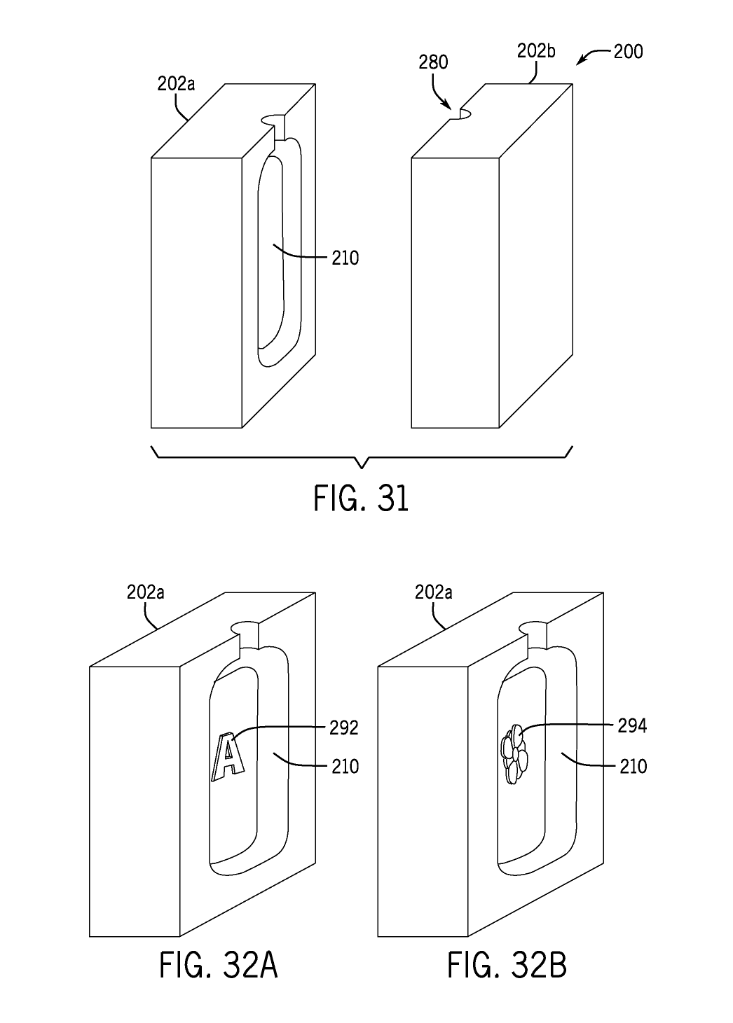

As indicated schematically in FIGS. 13A-13D, a bread product B is formed in a fixture shown as mold 200; the mold fixture 200 comprises two mold sections 202a and 202b that when closed form an open volume shown as mold cavity 210. See also FIGS. 31 and 32A-32B. The mold fixture has an inlet 280 through which the dough component D can be supplied (e.g. dispensed or injected under pressure) into mold cavity 210 to form a dough base (see FIGS. 13A-13B). The dough component D can fill or substantially fill the mold cavity 210 as the dough base for the bread product takes the intended form (subject to expansion during leavening for certain types and formulations of dough components); as the operation continues for the bread to be baked, the dough base will generally take the form of the mold cavity (see FIG. 13C). According to an exemplary embodiment, the bread product can be par-baked (e.g. “set” in form or shape) or baked within the mold fixture; the bread product can be formed in the mold fixture and baked or par-baked in a separate station (e.g. oven). The mold sections are separated to remove the bread product (e.g. formed dough component) from the mold fixture (see FIG. 13D) to provide a bread product B generally conformed to the shape of the mold cavity 210 (see FIG. 13E). As indicated, the molding operation for a bread product may generally follow a process similar to processes used for molding of plastics (e.g. blow-molding or injection molding) or other materials. As indicated the fixture (e.g. tooling and equipment) and operating conditions of the forming steps can be adapted for variations in the material properties such as the fragility and/or extensibility of the dough component and for production requirements for processing commercial foodstuffs (e.g. health and safety rules and regulations).

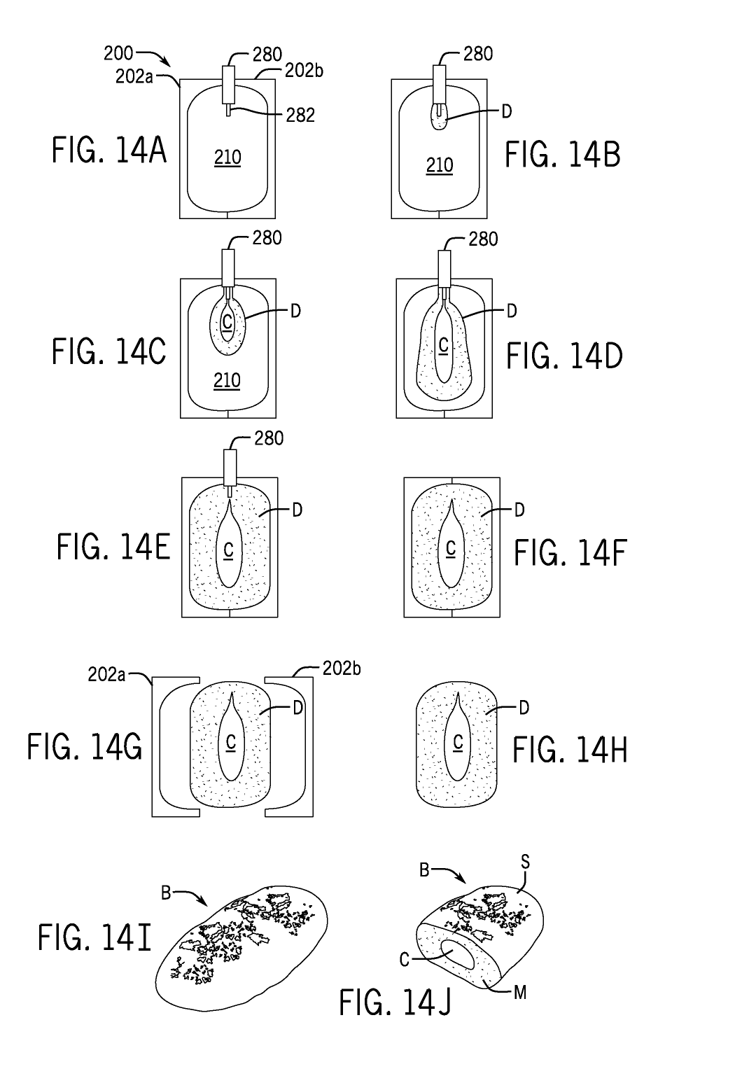

It is generally known to use a blow molding operation to form (from a plastic material) a part with a cavity. Such known principles are adapted and applied according to exemplary embodiments of the system and method for producing a bread product. For example, as shown representationally in FIGS. 14A-14H, 15A-15D, 16A-16D and 31, systems and methods to produce a bread product from according to exemplary embodiments can be adapted from known configurations, such as disclosed in U.S. Pat. No. 3,941,542, U.S. Pat. No. 3,635,632, U.S. Pat. No. 3,399,424 and U.S. Pat. No. 2,285,150.

Referring to FIGS. 14A-14J, as indicated schematically, the mold fixture may be configured for a blow-molding operation in which the dough component D is supplied (e.g. dispensed or injected under pressure) as a dough base into the mold cavity 210 through a port 282 of inlet 280 that is inserted into the mold and then retracted so that the dough component is expanded by supply of a fluid or gas (e.g. air or another gas) to conform to the interior walls of the mold cavity 210 while developing an interior cavity C in the forming bread product (see FIGS. 14B-14E). The bread product formed from the dough base within the mold fixture can be finished (e.g. baked or par-baked) and/or temporarily allowed to ferment or rise (see FIG. 14F). The bread product can be released from the mold fixture when the operation is completed by separating the mold sections 202a and 202b (e.g. mold halves, as shown schematically). (As indicated, the interior surface of the mold cavity may be treated with a suitable release agent or lined with a sheet or material to facilitate separation of the bread product from the opened mold fixture.) The bread product B formed from the dough component D will have an interior cavity C and generally not conform to the shape and form of the mold cavity (see FIG. 14H). As shown in FIGS. 141-14J, according to an exemplary embodiment, the baked molded bread product B upon finishing will have an exterior crust S and an interior crumb M as well as the interior cavity C. As shown in FIGS. 14A-14J, the baked molded bread product is formed from a dough base of a single dough component D.

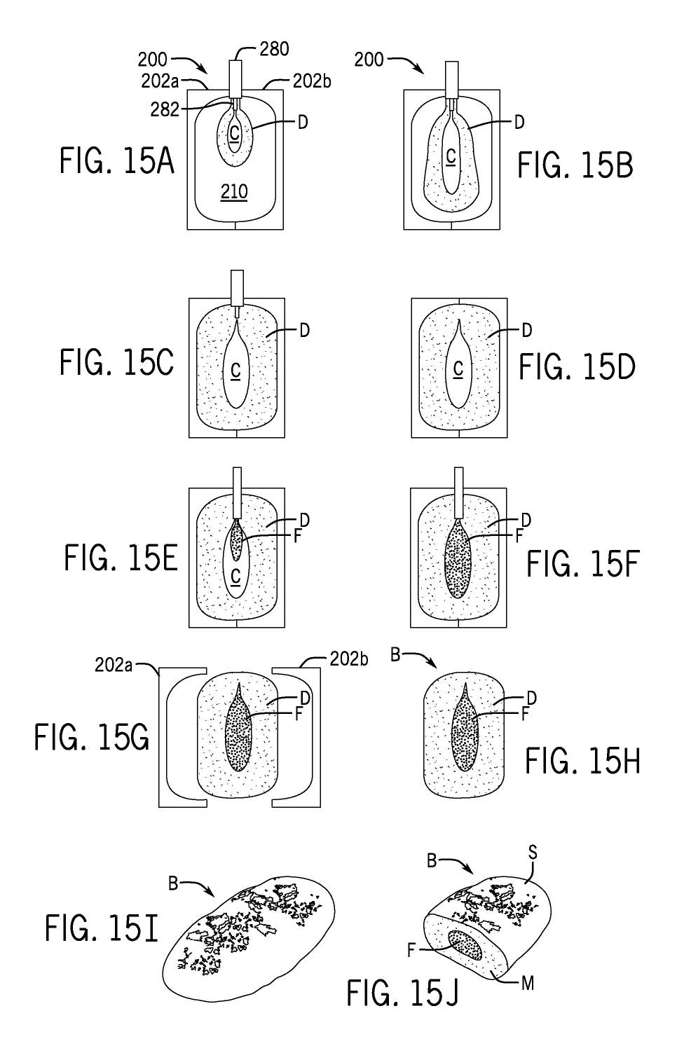

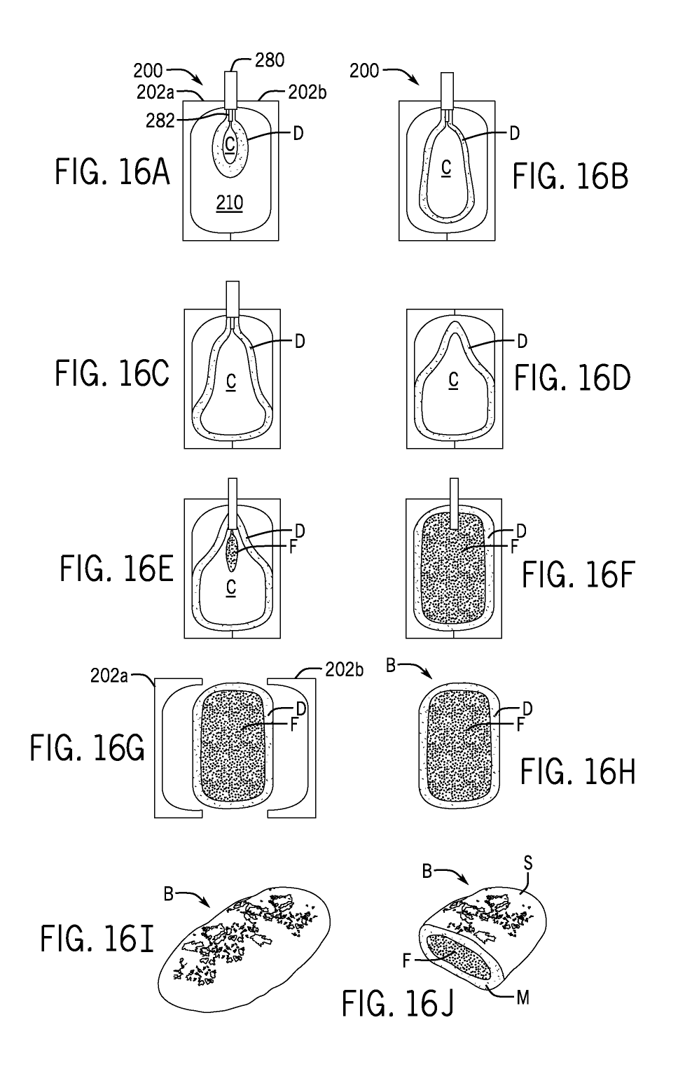

Referring to FIGS. 15A-15J, the mold fixture may be configured for a blow-modeling operation by the supply (e.g. injection under pressure) of a first (base) dough component D to form a dough base with a cavity C (see FIGS. 15A-15D) followed by the supply (e.g. injection under pressure) of a second (fill) dough component F into the cavity C tending to urge the dough component D to conform to the form of the mold cavity of given by the shape of the interior walls of the mold fixture as the fill component F fills and enlarges the cavity C in the dough base (see FIGS. 15E-15G). The two-component bread product can be finished (baked or par-baked) in the mold or removed and baked at a separate station. The mold sections of the mold fixture are separated to release the two-component bread product generally formed to the shape of the mold cavity (see FIGS. 15G-15H). As shown in FIGS. 151-15J, the baked molded multi-component bread product B upon finishing will have an exterior crust S and a two-component crumb formed of a crumb portion M_{D} of the first dough component D and a crumb portion M_{F} of the second (fill) dough component F. As indicated schematically in FIGS. 15A-15J and FIGS. 16A-16J, the relative respective volume and proportion of the first dough component and second (fill) dough component of the bread product may be adjusted according to exemplary embodiments. As shown in FIGS. 16A-16D and 16E-16H, the volume and resultant size (i.e. relative thickness) of the first dough component D may be reduced and the volume and resultant size (i.e. relative volume) of the second (fill) dough component F injected into cavity C may be enlarged so that the baked molded two-component bread product B has a generally thin crumb portion M formed of the first dough component D and a generally thick crumb portion of the second (fill) dough component F.

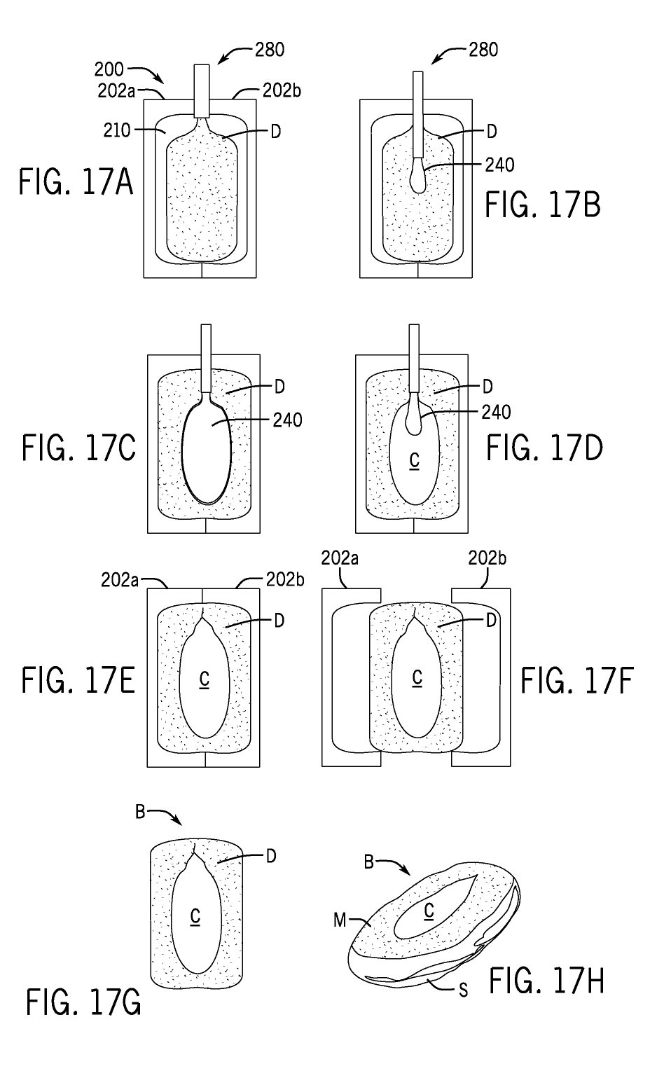

Referring to FIGS. 17A-17H, a molded baked bread product B with an internal cavity C may be formed in the mold fixture by partially filling the mold cavity with the dough component D to form a dough base and then deploying an inlet or port 280 into the dough component D and inflating a bladder or balloon 240 to expand the dough component D toward and into the side walls of the mold sections to conform to the shape of the mold cavity; the balloon 240 is then deflated and the port 280 retracted. As indicated, the balloon may be inflated and deflated in one or more cycles to more fully establish the cavity C within the dough component D (see FIGS. 17B-17D). The dough base may be finished (into a baked molded bread product or par-baked product) in the mold fixture or after release from the mold fixture; if the bread product is baked in the mold fixture, the balloon may be made of a heat-resistant material and may be deployed during the finishing operation (at an interval or in a cycle or maintained) to maintain the cavity C. As shown, after the cavity C has been established in the dough base, the dough component D is prepared to be finished (e.g. baked in the mold and/or released from the mold and baked at another station) (see FIGS. 17E-17G). The finished baked molded bread product B with crust S and a cavity C in crumb M (see cut-away view in FIG. 17H) is then ready for commercial distribution, sale, use and/or consumption.

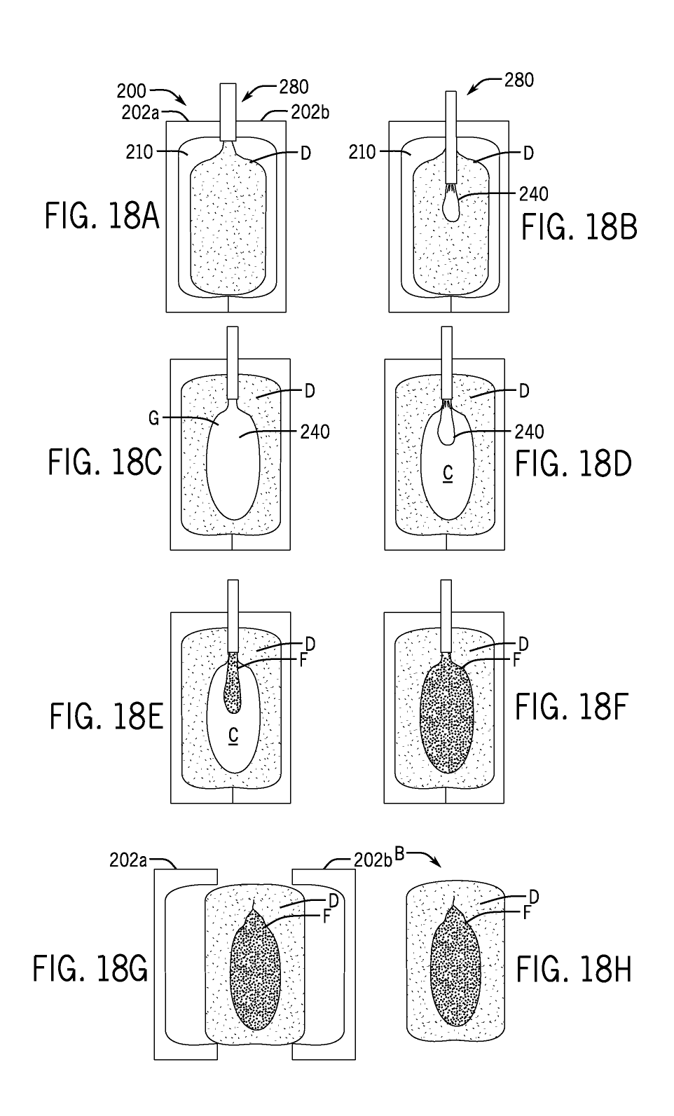

As shown in FIGS. 18A-18H, according to another exemplary embodiment, a baked molded bread products (formed from a dough (base) component D of the type shown in FIG. 17H) can be formed where the cavity C in the dough (based) component is filled with a separate dough (fill) component F. As shown, inlet 280 is used to supply the dough (fill) component F after balloon 240 has been inflated to form the cavity C and retracted from the dough (base) component D (see FIGS. 18A-18F). The cavity C provides a space or volume into which the dough (fill) component F can be supplied or injected. The two sections of the mold fixture can be separated to release the resultant two-component molded bread product B. If the bread product is according to one exemplary embodiment finished/baked in the mold fixture the baked bread product will be released in a form ready for packaging and/or sale and use; according to another exemplary embodiment, the mold fixture will release a formed two-component product to be finished/baked at a subsequent station. See FIGS. 18G-18H.

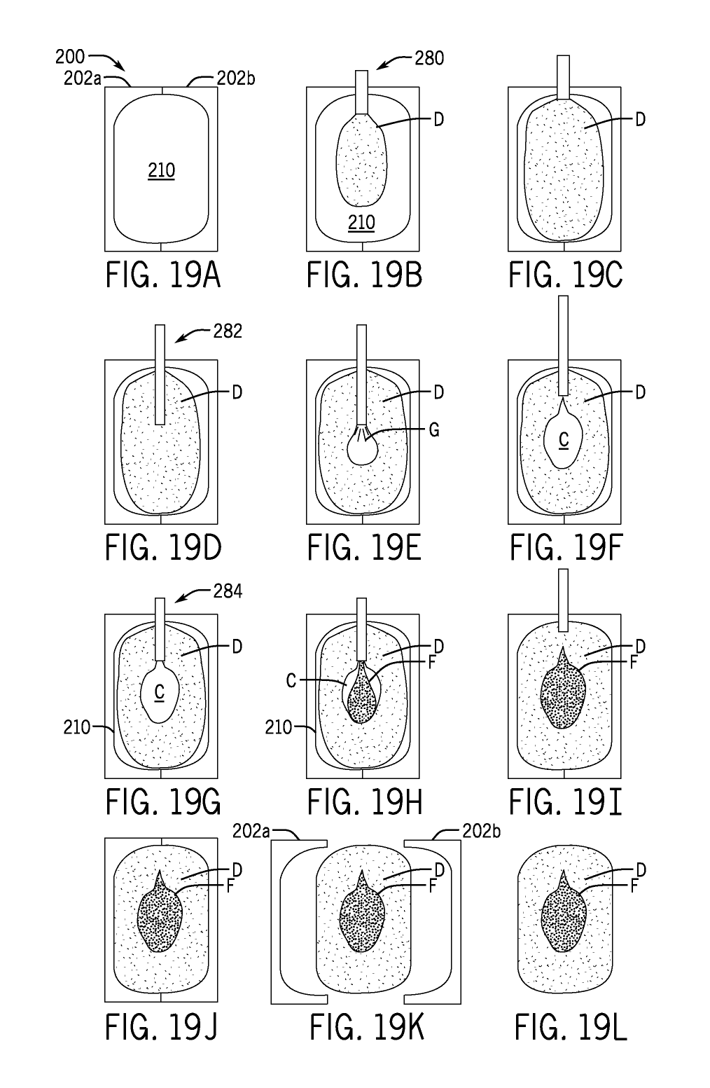

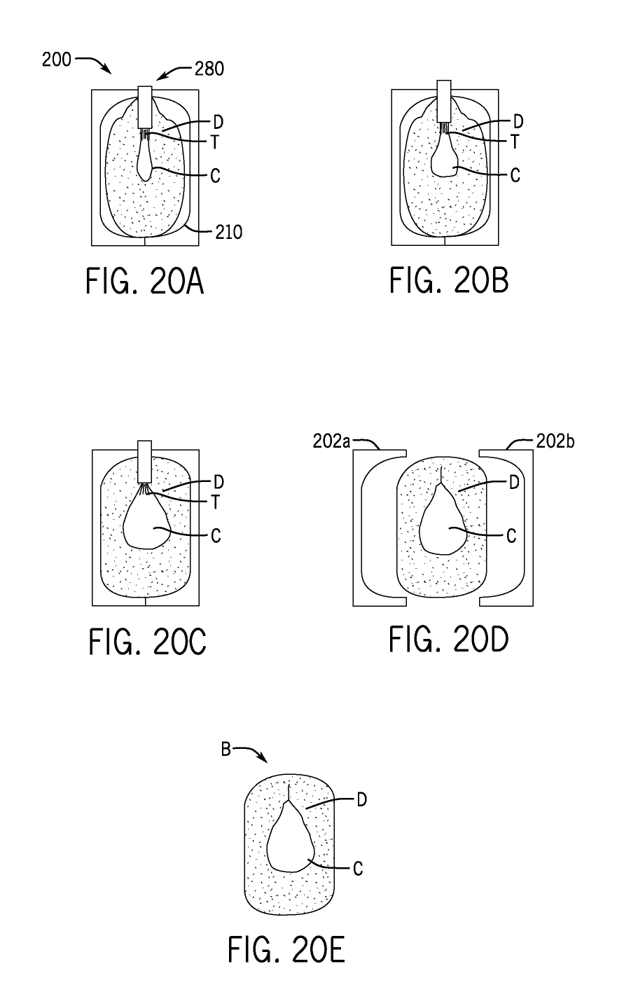

It is generally known to inject air into a dough mass to form or inflate a cavity within the dough mass. Such known principles are adapted and applied according to exemplary embodiments of the system and method to produce a bread product. For example, as shown representationally in FIGS. 19E-19G and 20A-20D, systems and methods to produce a bread product according to exemplary embodiments can be adapted from known configurations, such as disclosed in U.S. Patent Application Publication No. 2006/0060865. As shown schematically in FIGS. 19A-19L, a two-component baked molded bread product can be formed according to an exemplary embodiment where the cavity is formed in the (base) dough component D by a supply of a gas G (e.g. air, nitrogen/nitrous oxide, carbon dioxide, etc. under pressure) through a port or inlet shown as nozzle 280 to expand the dough (base) component D (see FIGS. 19B-19F) and form a cavity C. As shown, a dough (fill) component F may be supplied (i.e. dispensed or injected under pressure) into the cavity C through an inlet 280 to fill the cavity C and to conform the two-component product to the shape of the mold cavity 210 of the mold fixture (see FIGS. 19G-19J). The mold fixture can be opened to release the two-component molded baked bread product (if finished/baked in the mold fixture) or a two-component molded dough/bread product (to be finished/baked at a separate station). See FIGS. 19K-19L.

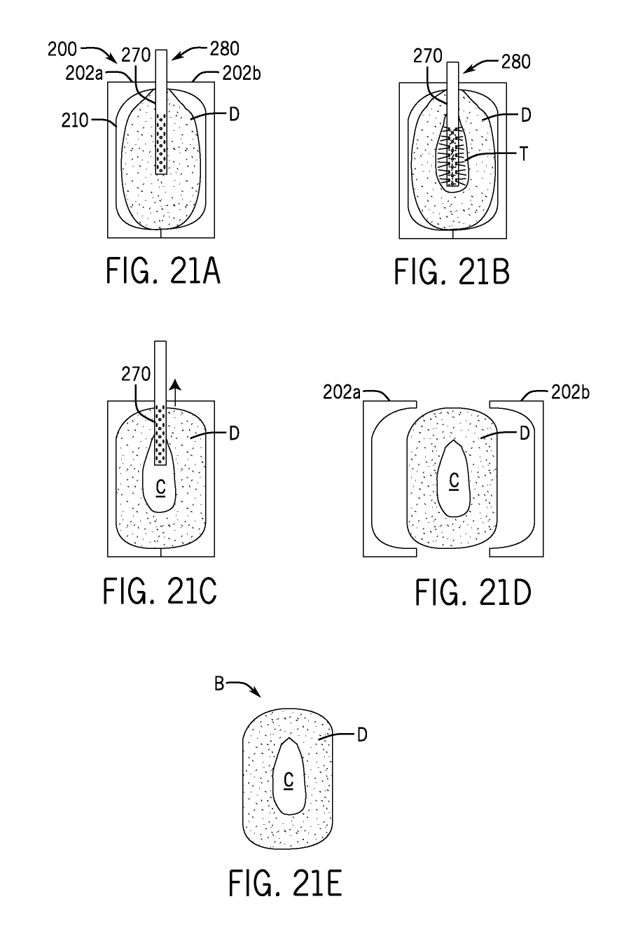

As shown schematically in FIGS. 20A-20E and FIGS. 21A-21E, according to alternative embodiments, the cavity C in the (base) dough component D in the mold fixture 200 can be formed by supply (e.g. injection) of a hot vapor such as steam T through a port or inlet shown as nozzle 280 which will have the effect of heating the dough component in the location of the formed cavity C; starch in the dough component at the location interior of cavity C may be gelatinized to “set” or establish the form of the cavity into a semi-rigid condition which is then more likely to be maintained in form (e.g. not as likely to collapse) during subsequent operations, for example, in handling after release from the mold fixture and transport to a separate station for finishing/baking. As shown schematically in FIGS. 21A-21E, according to an alternative embodiment, the steam may be supplied into the dough component D through a tool shown as spray head 270 configured to distribute steam T in a designated pattern to form and maintain/enlarge and establish the cavity C for the bread product. According to an alternative embodiment, the system may be configured to supply or spray a fluid to freeze the dough component adjacent to the cavity to achieve a “set” of the cavity in the dough base.

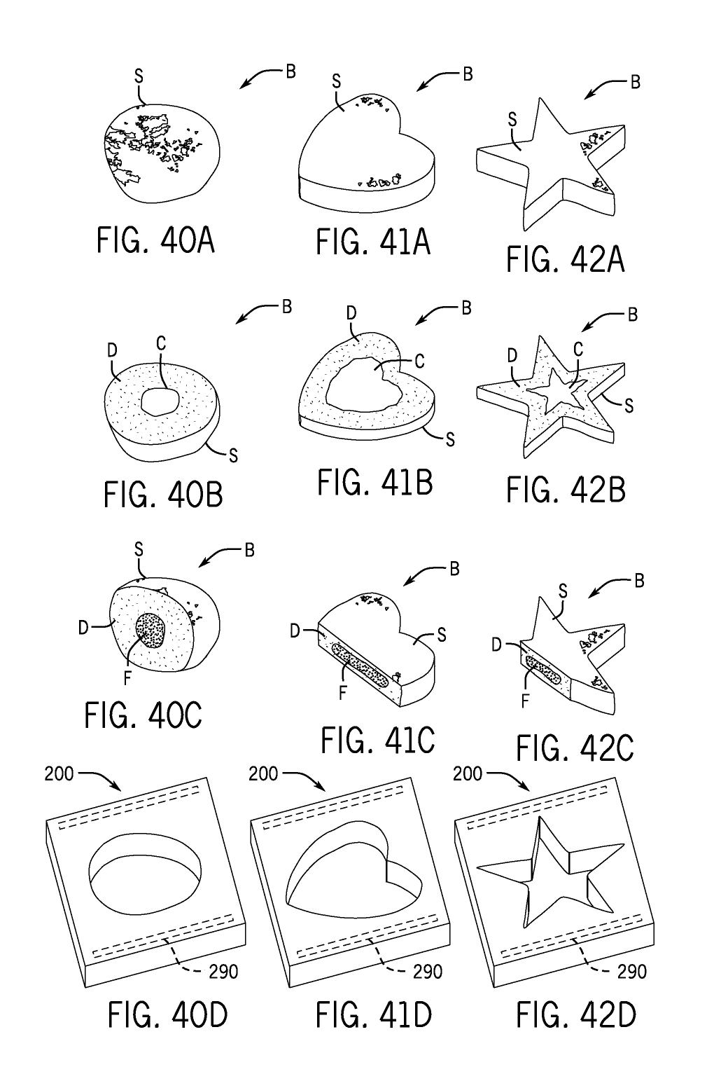

As indicated, according to an alternative embodiment, other methods of using heating or cooling/freezing to “set” the form of the cavity and/or the form of the dough component may be employed using conventional heat exchange technique. Thermal management of the mold fixture using heating or cooling elements (e.g. on or in the walls of the fixture or mold sections) may allow for management of material properties of the dough component (or dough components) to facilitate the efficient formation and production of the molded bread product; for example, initial heating of the supplied dough component in the mold fixture can be employed to enhance flow-ability (i.e. reduce viscosity) followed by cooling of the dough component to reduce flow-ability and reduce the degree of deformation (or to retard or suspend leavening) prior to finishing the molded baked bread product. For example, the system may include thermal elements 290 (e.g. representative of heat exchangers) shown schematically in mold fixtures 200 in FIGS. 40D, 41D and 42D; such elements may be shaped and installed and operated by a control program to facilitate thermal management of the process including the even and uniform baking of the molded bread product in the fixture. According to other exemplary embodiments, variations of the operations, sequencing of operations and operating conditions (e.g. time, temperature, humidity, air movement, etc.) may be managed as desired to produce particular baked bread products or particular characteristics in baked bread products including to adapt for variations in the dough component (or dough components) and to the physical form of the dough base formed into the bread product. According to a particularly preferred embodiment, each station comprises a control system (e.g. process control system or programmable controller) configured and networked to control the operation and operating conditions of the steps of the production process to achieve desired results for the resultant bread products.

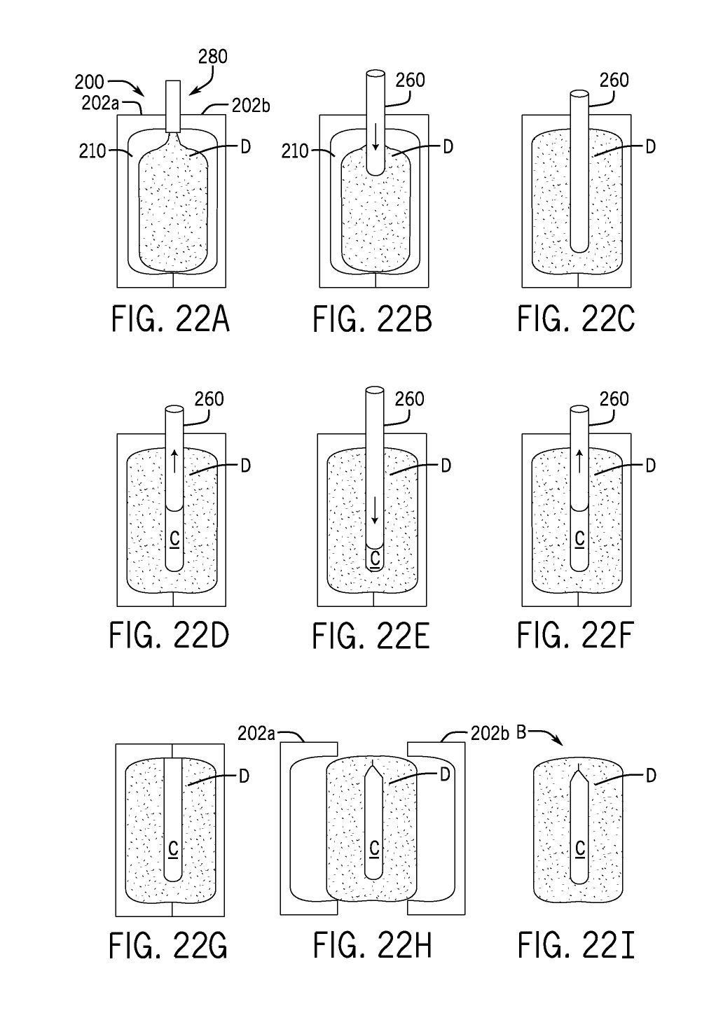

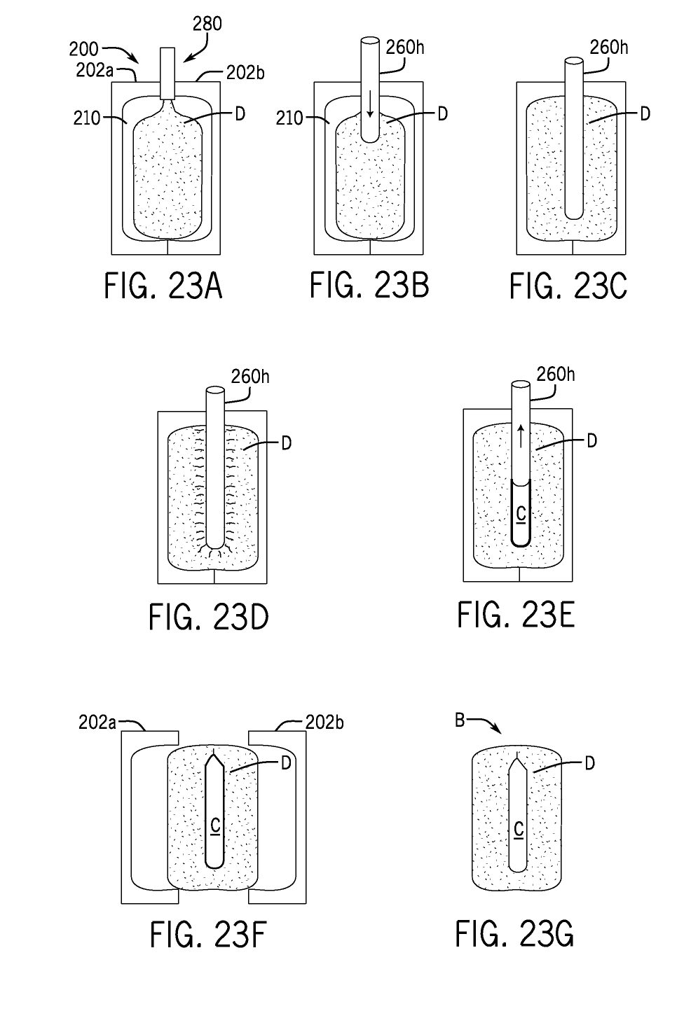

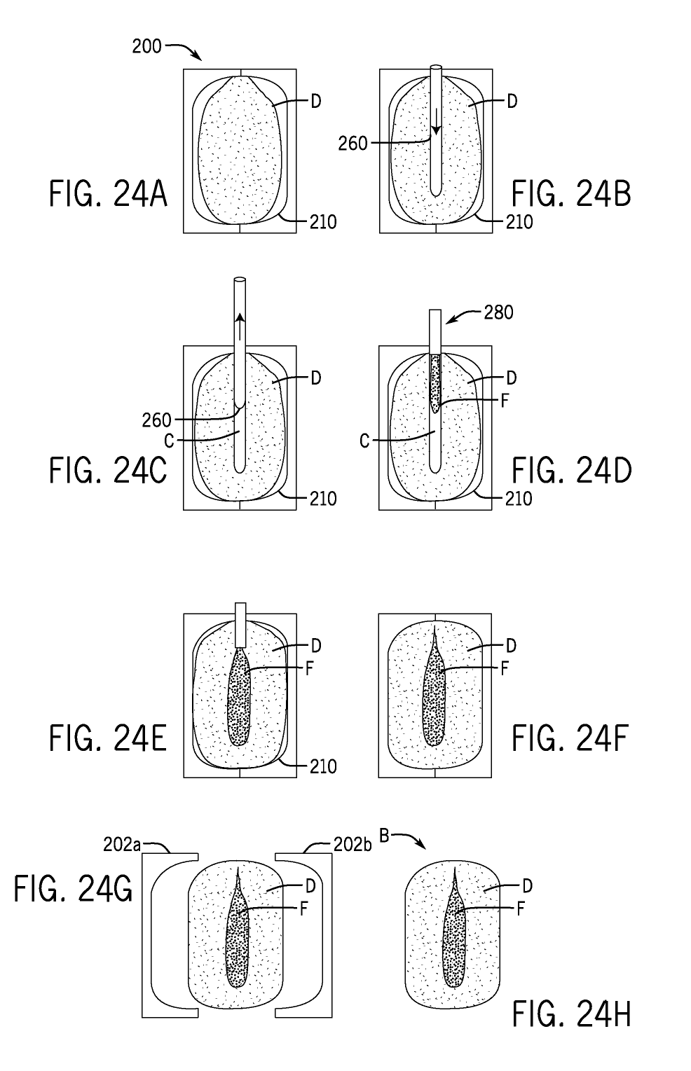

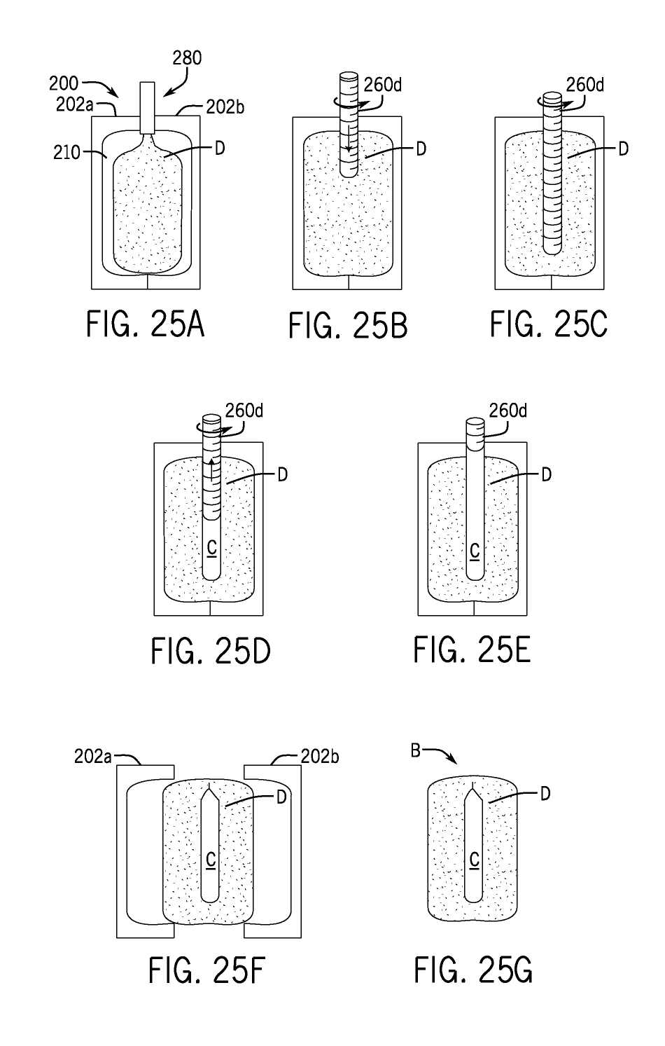

Referring to FIGS. 22A-22I, 23A-23G, 24A-24H and 25A-25G, according to other exemplary embodiments, mechanical tools or elements of various types may be used in the fixture to facilitate the formation of a distinct established cavity C in the dough component D of the dough base as to form a bread product with a cavity C or to form a two-component (or multi-component) bread product with a fill dough component F. For example, as shown schematically in FIGS. 22A-22I, the cavity C in the dough component D may be formed by insertion of a forming tool/member or mechanism shown as a mandrel 260; the tool or member or mandrel 260 may be inserted and removed in multiple cycles in the dough component to establish/form and maintain the size and shape of the cavity (see FIGS. 22C-22F). As shown schematically in FIGS. 23A-23G, the tool or mandrel may comprise a heating element configured to “set” the form and shape of the cavity C (e.g. by gelatinizing the starch at least partially at the dough component at the interior walls of the cavity C); after the cavity has been “set” the mandrel is removed. As shown schematically in FIGS. 24A-24H, after the tool or mandrel has been inserted to initially form the cavity C in dough component D a supply of fill component F can be injected into the cavity C (see FIGS. 24A-24E); excess fill component may be supplied to enlarge the initially formed cavity more fully so that a larger size of the filled cavity is formed in the bread product B (see FIGS. 24F-24H), As shown schematically in FIGS. 25A-25G, the forming tool may comprise a rotary drill apparatus configured to expel the portion of the dough component D of the dough base in the fixture that occupies the volume of the intended cavity C.

As indicated schematically in FIGS. 22-25, 26, 27-30, 31-32, 33-34, 35, 39 and 40-42, according to other exemplary and alternative embodiments, the fixture used to form the dough base into the molded bread product may be provided in a variety of forms (e.g. shapes, sizes, etc.) so as to produce a molded bread product generally in a corresponding variety of specialty and other/alternative forms (e.g. shapes, sizes, etc.). For example, the fixture may comprise a base or pan 202x into which the base dough component D (see FIGS. 33A-33D) or a two-component product with base dough component D and fill dough component F (see FIGS. 34A-34D) is dispensed or deposited; the fixture has a lid 290 so that the dough base for the bread product when proofed and/or baked can be formed to a designated shape. As indicated, the shape or shapes of the bread product or product produced in the system according to exemplary and alternative embodiments may vary according to the configuration of the fixture/apparatus and corresponding product design. Available shapes and forms may include various novelty shapes not particularly common at present for bread products in mass commercial distribution, see FIGS. 40A-40C (ball/sphere), 41A-41C (heart), 42A-42C (star), or other shapes. As also indicated in FIGS. 40A-40C, 41A-41C, and 42A-42C, after a cavity-forming operation on the dough base, the resultant bread product may have a cavity or filled cavity with a selected or corresponding shape.

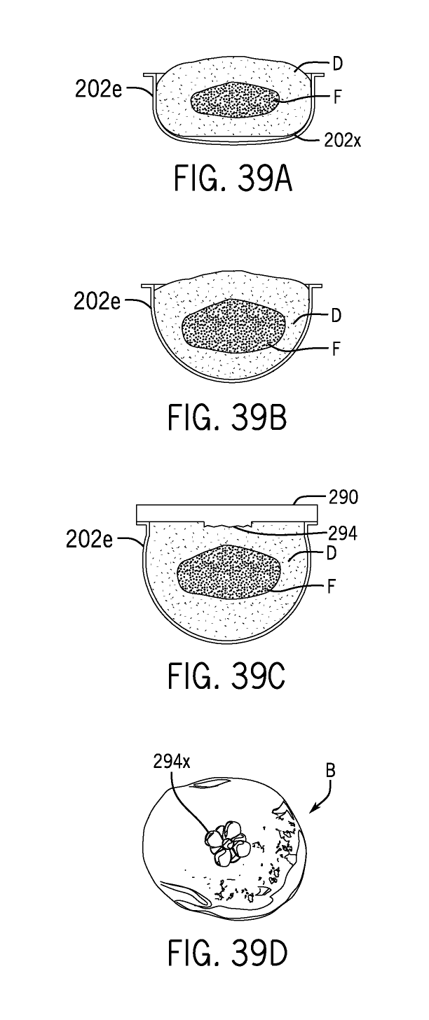

As shown schematically in FIGS. 39A-39C, the fixture may be configured with a base or pan that is formed of an expandable structure (e.g. a metal or elastomeric material) able to expand as the dough component (shown as a base component D with fill component F) is loaded or deposited and expands as proofed or baked to define the desired resultant form of the mold baked bread product (e.g. indicated as a ball/sphere in FIG. 39D). As shown representationally in the FIGURES, the mold fixture can be provided in a form corresponding to the intended form of the molded baked bread product; as indicated, any of a wide variety of conventional, artistic, decorative, novelty, specialty, alternative, custom, etc. forms may be provided for the fixture and the resultant bread product. As indicated schematically in FIGS. 40D, 41D and 42D, a mold fixture 290 may be configured with heat exchange or thermal elements 290 (e.g. within the mold sections) in the form of internal heating and/or cooling elements or flow passages, etc. adjacent the open mold cavity created when the mold sections are closed). With thermal elements the dough component can be thermally managed and/or finished (e.g. cooked or baked or par-baked and/or cooled/frozen) into a set (or final baked) form in a generally even manner to provide consistency and uniformity/evenness in the resultant finished/baked molded bread product notwithstanding the form or shape.

Referring to FIGS. 33E, 34E and 39D (as shown schematically) the mold fixture may be configured to impart an ornamental or referential or other visible designation to the exterior of the dough base forming the bread product. An embossment or design element may be provided in a mold section (see element 292 in FIG. 32A and element 294 in FIG. 32B) or lid of the mold fixture (see element 292 in FIGS. 33C-33D, element 294 in FIGS. 34C-34D and element 294 in FIG. 49C) that presents a resultant form or design in the bread product, for example, see form/letter 292x in the bread product B in FIG. 33E, form/design 294x in the bread product B in FIGS. 34E and 39D, etc. According to other exemplary embodiments (as indicated), the designation or design element can be provided in any of a wide variety of forms and shapes (e.g. designs, logos, trademarks, symbols, letters, words, etc. of different types and sizes) that could serve any of a wide variety of purposes (e.g. ornamental, artistic, informational, reference, commercial, personal or combinations of purposes).

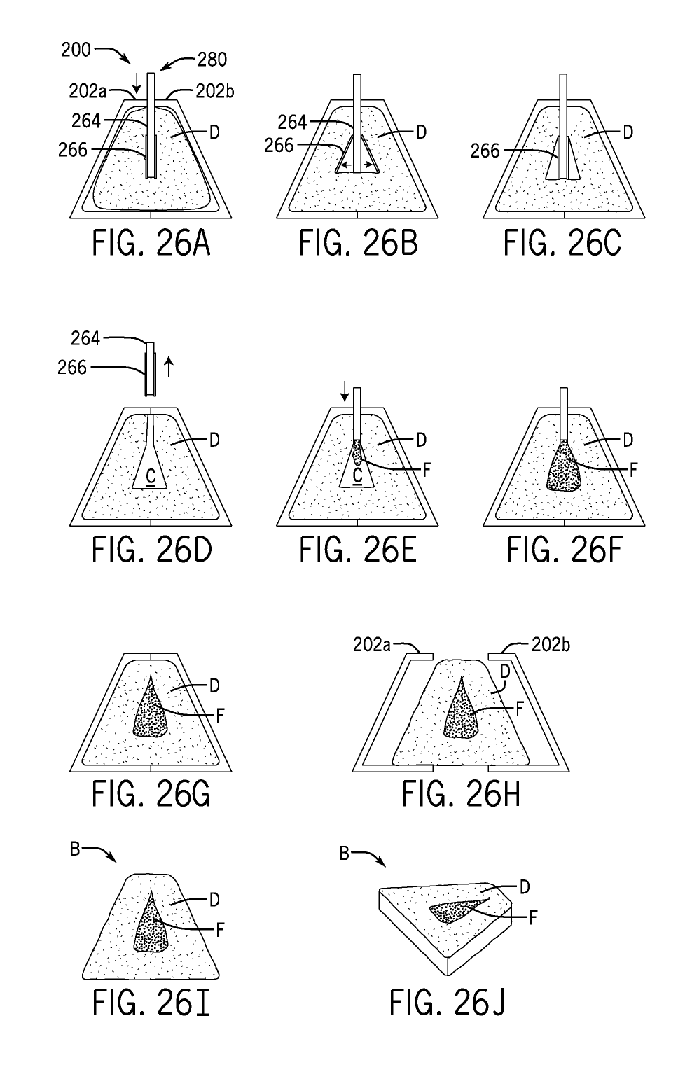

As shown in FIGS. 26A-26D, according to an alternative embodiment, the forming tool 264 may provide an expander mechanism 266 that is deployed to form and expand cavity C. As shown schematically (see FIGS. 26A-26H), the fixture used is wedge-shaped with sections 202a and 202b and produce a wedge-shaped molded bread product B (see FIGS. 26I-26J); as indicated, the wedge-shaped bread product B is a multi-component bread product formed of a base dough component D and a fill component F. As shown schematically, after the dough base of dough component D has been supplied within the mold cavity a tool is used to form the wedge-shaped cavity C; the tool 264 initially forms an initial cavity in the dough component but also comprises a mechanism with arms or flaps shown as elements 266 that extend outward when actuated to create an enlarged wedge-shaped cavity C from that initial cavity as shown schematically in FIGS. 26A-26E; the tool also conforms the shape of the dough base to the shape of the cavity within the mold fixture. The fill dough component F can then be supplied into the cavity C in the base dough component D through a port or inlet 280 inserted into the mold fixture 200 as shown schematically in FIGS. 26F-26G. (According to an exemplary embodiment the tool may be configured to provide the port or inlet for the dough components and/or gas or steam/vapor to assist the formation and establishment of the cavity.) After the fill dough component has been supplied into the cavity the multi-component product may be released from the mold fixture by separating the mold sections and then transported to a finishing station to be finished (e.g. baked or par-baked and/or frozen) or the multi-component product may be finished within the mold fixture (e.g. baked or par-baked and/or frozen). See FIGS. 26H-26I. As shown schematically (in cut-away/cross-section) in FIG. 26J, the resultant baked bread product B is a multi-component wedge-shaped bread product having a crumb portion formed of the fill dough component F and a crumb portion of the base dough component D.

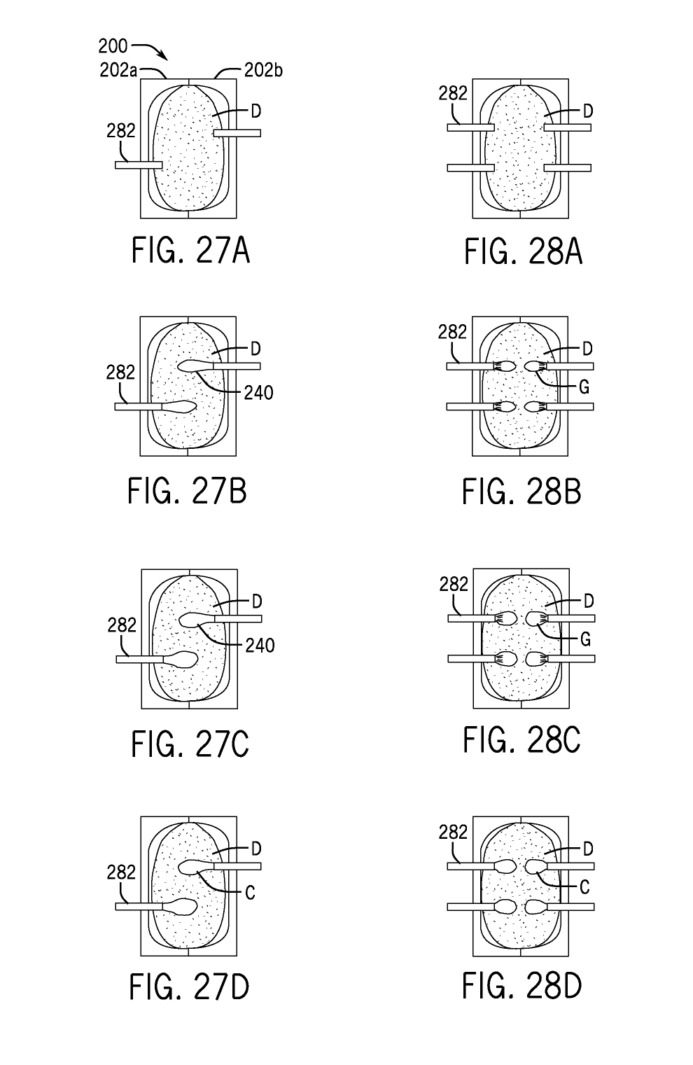

Referring to FIGS. 27A-30G, systems and methods of forming a baked molded bread product in a mold fixture 200 having sections 202a and 202b from a dough base of a dough component D are shown schematically according to alternative embodiments. Example two-component bread products formed of a dough component D and having multiple sections of fill material are shown in FIG. 29G (two sections) and FIG. 30G (four sections); according to alternative embodiments, bread products may be formed with multiple cavities (e.g. two, three, four, etc., or a combination of the filled cavities F and open cavities C as shown in FIG. 29H); as indicated, the system may be configured to produce a variety of bread products with a wide of differing arrangements of fill sections and/or combinations of multiple fill material types and/or combinations of fill sections and open cavity sections.

As shown schematically in FIGS. 27A-27D and FIGS. 28A-28D, according to an exemplary embodiment, the bread product may comprise multiple cavity sections C in the dough base formed by dough component D filled from inlets 280 using a bladder or balloon 240 (FIGS. 27A-27D) or a supplied fluid G (e.g. gas or vapor injected under pressure) (FIGS. 28A-28D). As shown in FIGS. 29A-29G and FIGS. 30A-30G, the bread product may comprise multiple fill sections F in the dough component D each formed by supply through inlet 282 of fill component F. The resultant multi-component (multi-fill and/or multi-cavity) bread product may be finished at a separate station (e.g. baked or par-baked and/or frozen) while in the mold fixture or released from the mold fixture to be finished (e.g. baked or par-baked and/or frozen).

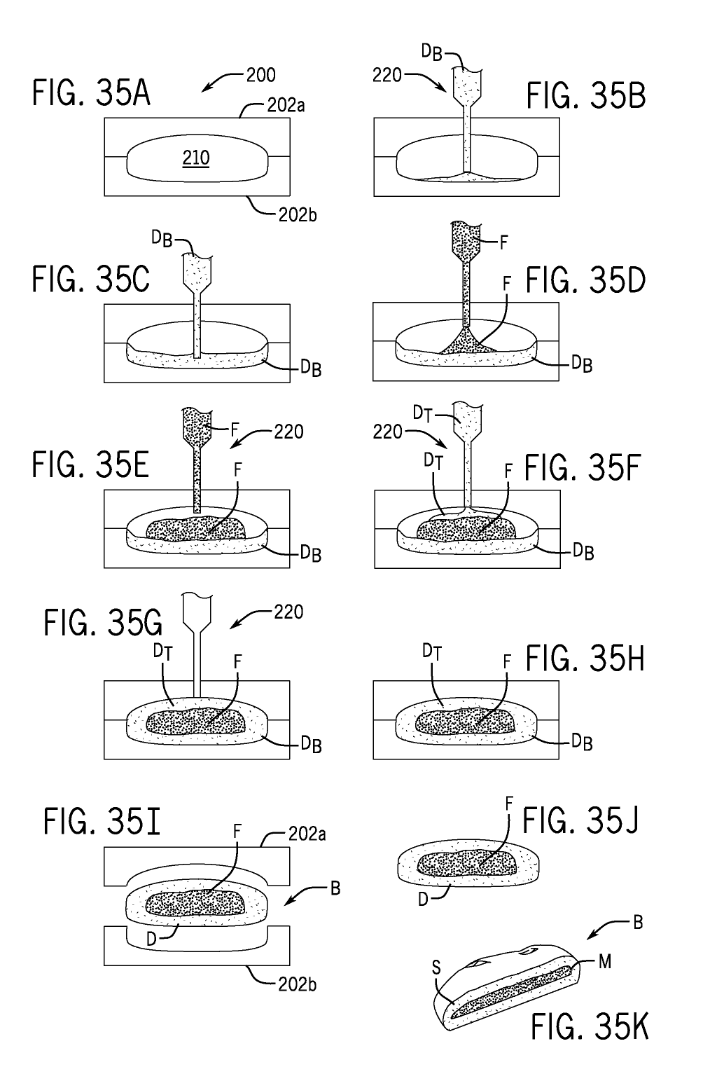

It is generally known to form multi-component foodstuffs in a mold fixture in which the components are injected. Such known principles are adapted and applied according to exemplary embodiments of the system and method of producing a bread product. For example, as shown representationally in FIGS. 35A-35I, systems and methods to produce a bread product according to exemplary embodiments can be adapted from known configurations, such as disclosed in disclosed in U.S. Pat. No. 8,124,156. As shown in FIG. 35A-35J, a sequence of steps can be employed to form a multi-component bread product in a mold or fixture 200 that will have a form as shown in FIGS. 35J-35K. Mold 200 has a section 202a and a section 202b that are closed and sealed together to create a cavity 210 as shown schematically in FIG. 35A. Dough component D_{B} for a bottom layer L_{B} is dispensed from dispenser 200 into the cavity 210 (see FIGS. 35B-35C); dough component F for a fill in the center is then dispensed from dispenser 200 into the cavity 210 atop the dough component D_{B} forming the bottom layer L_{B} (see FIGS. 35D-35E) from dispenser 200. Dough component D_{T} for a top layer L_{T} is then dispensed from dispenser 200 into the cavity atop the 210 dough component for the fill at center F (see FIGS. 35F-35G). As indicated, each dough component is liquefied sufficiently (e.g. mixed, treated, diluted into a batter etc.) to facilitate flow into the cavity of the mold or fixture (while suitably retaining segregation of the fill dough component). The multi-component bread product may be removed from the mold by separation of the mold sections (see FIG. 35I). The resultant bread product B is a multi-component baked bread product where the fill dough component F is finished/formed into the crumb M and the top layer dough component D/L_{B} at the exterior finished/formed into a crust S, as shown in FIGS. 35J-35K.

According to an exemplary embodiment, the forming station may be configured to operate under a non-atmospheric pressure (elevated pressure or reduced pressure) to produce an intended effect on the dough base (and/or fill material) used to form the bread product. For example, the forming operation or other steps in production may occur under attenuated pressure (e.g. in vacuum and/or with headspace pumped with nitrogen or oxygen or another gas). Variations of the crumb structure of the corresponding baked bread product may result from variations of pressures or variations in the gas/vapor used in operation of the fixture and forming station. As indicated, the apparatus of the forming station (e.g. fixtures/tooling, mold fixtures/sections and/or other components) may be configured to allow use of such techniques in production or operation as may otherwise be difficult to employ in the production of a bread product (e.g. for the process of filling in the mold fixture, forming the cavity, filling the cavity, etc.); resultant variations in the form and characteristics of a baked bread product produced under variations in operating conditions can be tested/evaluated as to allow identification of potential improvements/modifications in bread products available to be produced through such techniques.

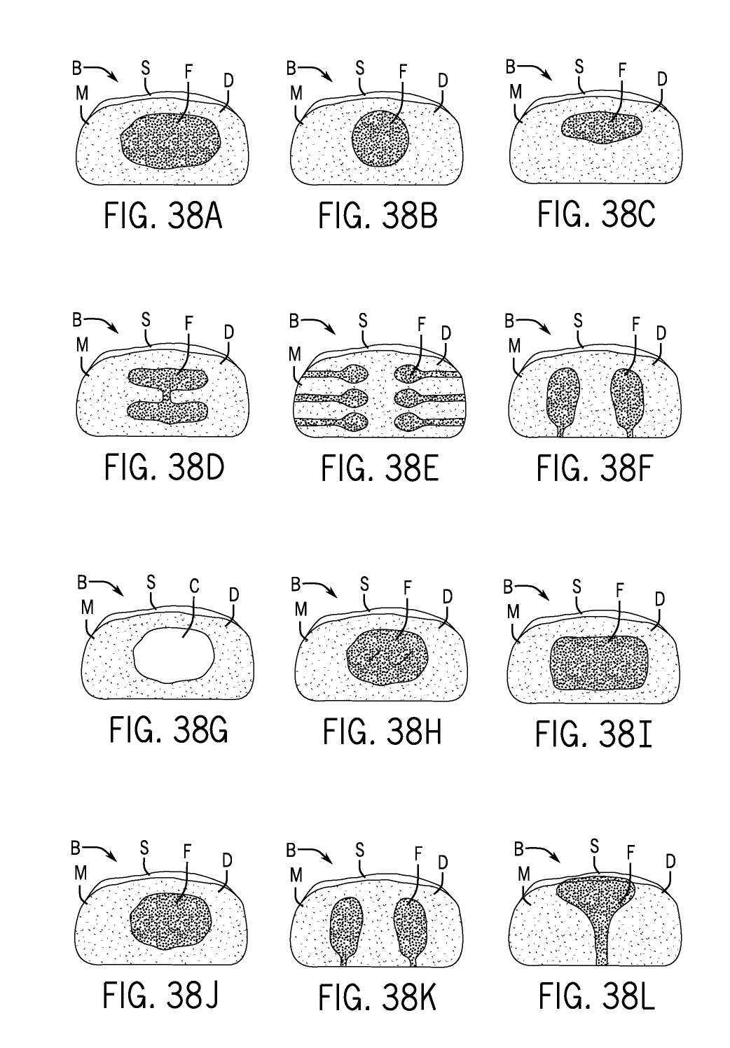

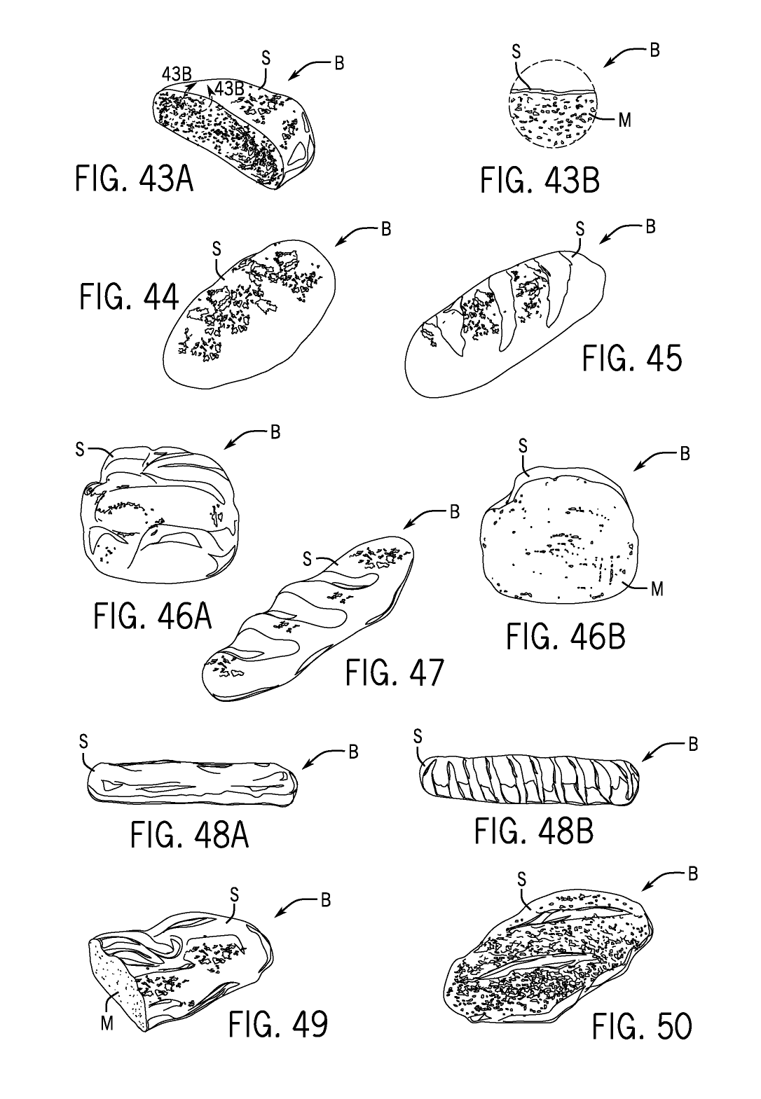

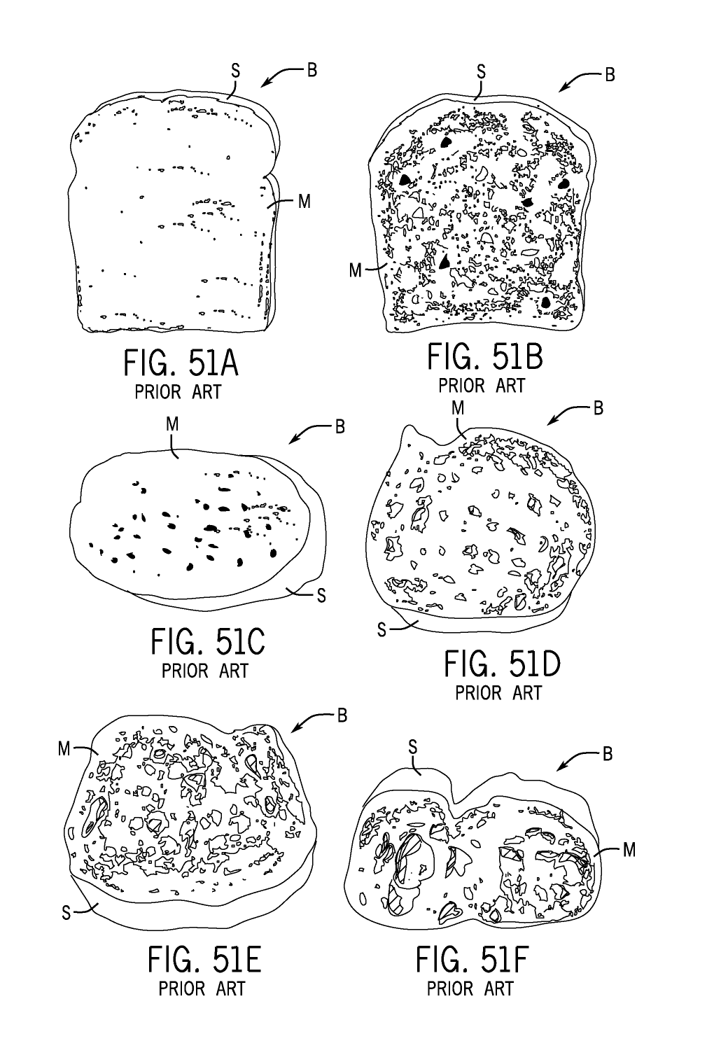

Referring to FIGS. 38A-38J, a wide variety of representational forms of fill and/or cavity arrangements that may be produced according to exemplary embodiments are shown schematically. Representational types of example bread products that may be produced according to exemplary embodiments are shown in FIGS. 43A-50. Known forms and textures of bread products now produced that may be provided in products produced according to exemplary embodiments are shown representationally in FIGS. 51A-51F.

It is generally known to employ extrusion processes for producing multi-component foodstuffs (including from a dough components). Such known principles are adapted and applied according to exemplary embodiments of the system and method of producing a bread product. For example, as shown representationally in FIGS. 36 and 37A-37C, systems and methods to produce a bread product according to exemplary embodiments can be adapted from known configurations, such as disclosed in U.S. Pat. No. 4,786,243, U.S. Pat. No. 4,882,185, U.S. Pat. No. 4,251,201, U.S. Pat. No. 4,698,000, U.S. Pat. No. 4,469,475, U.S. Pat. No. 4,266,920, etc. Referring to FIG. 36, according to an exemplary embodiment (shown schematically) an apparatus shown as co-extrusion system 300 mixes and dispenses each dough component of the multi-component bread product. Co-extrusion system 300 comprises a vessel shown as mixing vat 310 with rotary mixing feeder arms 312 for the fill dough component for the center portion F of the bread product and a vessel shown as vat 320 with a rotary screw feeder 322 for the base dough component for the outer portion D of the bread product.

As shown generally in FIG. 36, base dough component D is mixed (from ingredients) and dispensed from vat 310 into an outlet passage while fill dough component F is mixed from ingredients and dispensed from vat 312 into an outlet passage. The outlet passage for the fill dough component has an annular form around the passage for the base dough component F; the dough components flow to a common passage and outlet at the end of the annular passage where dough component D is no longer separated from dough component; the resultant bread product has a co-extruded form in which dough component D is applied around dough component F as dispensed at the outlet of the co-extrusion system 300. As shown schematically in two separate cross-section views in FIG. 36, according to one exemplary embodiment, the bread product will have the dough component for the outer portion D encompassing the dough component for the fill portion F in the resultant co-extruded multi-component bread product. The co-extruded multi-component bread product can be cut to length and formed at the respective ends by a mechanism comprising gate 350 as indicated schematically in FIG. 36 and then baked to produce a baked co-extruded multi-component bread product B having a crust S (corresponding to the exterior of the dough component of outer portion D) and a crumb M (substantially corresponding to the dough component of fill portion F). As schematically shown in FIG. 36, a gate or forming tool such as cutting element 350 may operate in a reciprocating cutting action at a specified interval to segment the co-extruded form into bread products of specified or intended lengths.

As indicated schematically in FIGS. 37A-37C, according to other exemplary and alternative embodiments, the system may be configured (e.g. by arrangement of the flow paths for the dough components) to form a wide variety of extruded bread products that have any of a wide variety of forms and patterns of combination of the dough components. For example, as shown in FIGS. 37B and 37C, the bread product may have a striped or striated pattern of the fill dough component F within the base dough component D.

According to other exemplary embodiments, the co-extrusion system or extrusion system may be of any type suitable for formation and handling of a multi-component bread product. As indicated according to known principles, sizing and arrangement and configuration of the elements of the system can be adapted/modified or adjusted to form extruded bread products that have a desired overall shape and proportion and a desired thickness of outer portion D around to center fill portion F for the purpose or requirements. According to any preferred embodiment, the ingredients for each dough component of the multi-component bread product may be selected and formulated so that the baked bread product exhibits desired characteristics of crust and crumb. According to other exemplary embodiments as indicated, the extruded bread product may be provided in any of a wide variety of forms and shapes (e.g. designs of different types and sizes) that could serve any of a wide variety of purposes (e.g. ornamental, artistic, informational, reference, commercial, personal or combinations of purposes).

Dough components may also be selected and combined by other characteristics intended to facilitate the forming operation (such as viscosity, flow-ability, density, adhesion, etc.). Operating conditions for the forming operation (e.g. temperature, time, humidity, air movement, etc.) may also be adjusted or adapted to facilitate or establish characteristics of the dough components (e.g. to facilitate release at the surface of the mold fixture). Surface treatments or other preparations may be employed to facilitate the forming process (e.g. other compositions may be applied to the mold fixture or as ingredients in the dough component before supply or injection of the dough component).

As indicated, the system and method is intended to facilitate the commercial production of bread products that have characteristics and features/attributes that consumers will appreciate and find appealing, for various reasons. For example, bread products formed with a distinct cavity can be given any of a wide variety of uses by consumers in that form (e.g. as a bread bowl, for sandwiches, etc.); bread products formed with a cavity may have the cavity filled with any of a wide variety of fill materials (during production or after the bread product has been finished into a product for commercial distribution) for any of a wide variety of uses. Multi-component bread products formed from different dough components may be provided in a variety of forms that enhance appeal and/or usefulness to consumers. As indicated, bread products produced according to embodiments of the system and method may be provided in a variety of different forms, shapes and sizes, including with adaptations to facilitate usefulness and appeal to particular groups of consumers. For example, bread products according to exemplary and other embodiments may be produced in sizes and shapes suitable for use and consumption by a single person (e.g. as a bread bowl for a serving of soup or as a sandwich) or in a sizes and shapes suitable for use and consumption by groups of people (e.g. for families, parties/gatherings, restaurant/commercial food service, institutional/cafeteria service, etc.).

According to exemplary and other embodiments, the bread products produced by the system and method will have a flavor and taste (among other characteristics) is appealing to consumers. According to the exemplary and other embodiments, the bread products produced by the system and method will exhibit characteristics such as form and texture (among other characteristics) that are generally exhibited by bread products that are found to be appealing by consumers. For example, notwithstanding that the system and method allows for bread products to be produced in a high-volume operation, the bread products may exhibit the characteristics commonly exhibited by artisan breads that many consumers find to be appealing and attractive. According to exemplary and other embodiments, the bread products produced by the system and method may gain enhanced consumer appeal from the form and shape that is given the bread product. Consumer appeal for the bread products may be enhanced, for example, by that such bread products are available in forms and shapes that consumers find to be aesthetically-pleasing, that consumers find to be attractive and unique/novel, that consumers can order or select by theme for particular holidays and other occasions and events, that consumers find to be more useful or suitable for particular uses, etc. As contemplated according to exemplary embodiments of the system and method, the characteristics, features/attributes and available uses of bread products produced by the system and method will be found to have appeal to a wide variety of consumers for a wide variety of reasons, general and specific.

### Example Formulation of Dough Components

Specific formulations of the dough component (or dough components) for a bread product according to exemplary embodiments can be determined by the type of bread product intended to be produced and desired characteristics intended to be obtained in the bread product. According to any exemplary embodiment, formulations of a dough component may be adjusted or adapted for particular purposes as determined by the situation or need. As also understood to those of skill in the art, independent of the specific formulations of the dough components, other factors can affect the texture or flavor of a baked bread product, for example, mixing techniques, fermentation time, and the operating conditions of the baking/cooking procedure. According to any preferred embodiment, each dough component may be formulated to produce desired effects in the baked bread product, such as flavor, aroma, texture, consistency, color, shape, size, mass/density, shelf-life, nutritional value, etc.

Formulations for the dough components are expressed (by weight) in what is called a “baker's percentage” where the flour (or type of flour) that makes up the bulk of the formula is expressed as 100 percent (one unit) and all other ingredients are scale-based (by weight) on the unit of flour of the formulation of the dough component.

As an example, a formulation for a baguette may be expressed as shown in TABLE 1. As indicated, the percentages of each ingredient may be adjusted within ranges and to suit the operating conditions for baking the bread product; suitable substitutions may also be employed for certain ingredients as or if necessary or appropriate.

Flour and water with a suitable amount of salt mixed to a suitable consistency will generally formulate a dough component suitable to produce bread products using the processes outlined in the exemplary embodiments. Other functional ingredient such as improvers and additives and garnishes, etc., may also be included in the formulation of the dough component for a bread product. Pre-hydrated starches and flours and flavorful liquids (instead of water) could be used according to other exemplary embodiments of a dough composition. According to any preferred embodiment, the dough component will be formulated to withstand the processes while yielding a baked bread product that is flavorful and functional for the intended purpose.

Other tools and techniques could be employed to affect and alter the flavor and texture of the end (baked) bread product made from the dough components. For example, according to exemplary embodiments, part of the mix of ingredients of the dough components could be pre-gelatinized, additives and garnishes (e.g. nuts, cheese, dry fruit, etc.); other known means for adjusting or improving the blend of flour and ingredients in a dough component could be used. As known to those of skill in the art, there are a wide range of ingredients and options for formulating a suitable dough component or dough components; no suitable formulation of dough component for a bread product is intended to be excluded according to the exemplary embodiments.

### Example A

To provide a rich or dense enriched dough component for the dough component (to which the outer layer would be applied) as the crust of the baked bread product an example formulation may comprise the formulation shown in TABLE 2.

As indicated, the percentages of each ingredient may be adjusted within ranges and to suit the operating conditions for baking the bread product; suitable substitutions may also be employed for certain ingredients as or if necessary or appropriate.

### Example B

Composition of batter (liquid) that could be deposited into a mold to form the baked bread product may be formulated according to various exemplary embodiments. A composition or formulation of a batter or slurry that could be applied to the dough may comprise flour 100 percent and water 500 percent (or in any event a higher proportion to enhance flowability for the forming process, see, e.g., FIGS. 35A-35I).

According to other exemplary embodiments the variation of proportion of water to flour may be adjusted according to the apparatus and operating conditions for the process/procedure.

As indicated, the percentages of each ingredient may be adjusted within ranges and to suit the operating conditions for baking the bread product; suitable substitutions may also be employed for certain ingredients as or if necessary or appropriate.

### Other Ingredients/Improvers/Variations

According to exemplary embodiments, as indicated, the formulation of ingredients for the dough component of bread products (including the type or source of flour) and various other ingredients may be varied widely to suit the intent and/or other needs or requirements for a particular application or bread product such as to enhance rise (leavening) and extensibility (e.g. workability of the dough component for the process/procedures). Ingredients and additives may be included in a dough component for any of a number of reasons, including to enhance the forming, structure/stability, flavor, appearance, shelf life, nutritional value or content/composition, etc. of the resultant bread product.

According to any exemplary embodiment, improvers for the dough components that serve a functional role in the preparation or manufacture of a baked bread product may be employed. Such improvers may comprise the additives and ingredients listed in TABLE 3.

Composition of an example dough component used (for base or fill) in the bread product may comprise any of a wide variety of ingredients and flour types (e.g., wheat flour, rice flour, etc.), along with sugar, yeast, salt, water, oil, etc. in suitable percentages, according to various exemplary embodiments selected and formulated to provide suitable characteristics for the bread product.

As indicated, any ranges provided for ingredients of any dough component according to various exemplary embodiments are approximate; percentage ranges of ingredients could be varied (even widely) according to other exemplary and alternative embodiments. According to various exemplary embodiments, in the formulation of a dough component, bread flour could be replaced with and all-purpose flour or “00” durum flour or other functional flour for the system/method or product. For example, the flour for the dough component could be a blend with constituents/ingredients mixed in a range; for example, approximately 50 percent bread flour and approximately 50 percent all-purpose flour would provide a more tender consistency; small percentages (e.g. around 10 percent of the flour) could include whole wheat flour or other whole grain flours (e.g. quinoa, etc.), in formulations of the dough component that can be adapted according to cultural/popular tastes or other appeal. Such formulations may be developed for the system and method to give the final product distinct texture and flavors (or as part of a marketing strategy targeting certain customer desires, such as for a product that can be considered or perceived as healthier, etc.).

According to various exemplary embodiments, water could be provided in any of a range of percentages; for example, according to one exemplary embodiment, water may be in a range of between approximately 60 and 75 percent (as workable). Other formulations may alter combinations of water and improvers; for example, a wetter dough component (approximately 75 percent hydration) would be more workable if it included approximately 5 percent (vital) wheat gluten. flavorful liquid could be substituted for water (in some form); for example, a tomato-water stock or a mushroom stock may be used to flavor the dough component; other desired flavors may also be put into the dough component through ingredients or other ranges of other additives that are flavorful. According to an exemplary embodiment, tomato/mushroom powders (e.g. approximately 3-5 percent) could be added to the dough component; additions of dried powders (e.g. tomato, mushroom, etc.) would start to build flavors into the dough component before other ingredients are mixed into the dough component. According to various exemplary embodiments, salt could be in approximately a 1-2 percent range. Sugars or other sweeteners may be added to the dough component.

According to various exemplary embodiments, instant yeast concentrations could range up to approximately 1 percent (e.g. depending on how quickly one is trying to manufacture the product). According to an alternative embodiment, fresh yeast may be used (e.g. usually used at about three times the weight of instant yeast, and thus approximately 1-3 percent). Other leavening agents could be used in conjunction with the yeast; for example, encapsulated leavening agents (e.g. in concentrations of approximately 0.25-0.75 percent) may be provided to aid in rise during baking (e.g. will not activate until the dough component reaches a certain temperature).

According to other exemplary embodiments, the dough component for the dough base could be produced using any number of proprietary blends commercially available from suppliers (for example, including various combinations and blends of the ingredients in TABLE 3). According to another exemplary embodiment, the system and method could be implemented and/or adapted to produce non-gluten bread products; for example, gluten-free flours such as rice, oat, amaranth, potato, sorghum, and tapioca could be used in various formulations of a dough component. Gums such as xanthan or carrageenan could be provided as improvers/ingredients for the dough component according to exemplary embodiments. According to an exemplary embodiment, esters (in powder/granular form) may be added as an improver/ingredient to the dough component (e.g. to add fermentative flavor).

It is important to note that the construction and arrangement of the elements of the inventions as described in system and method and as shown in the figures above is illustrative only. Although some embodiments of the present inventions have been described in detail in this disclosure, those skilled in the art who review this disclosure will readily appreciate that many modifications are possible without materially departing from the novel teachings and advantages of the subject matter recited. Accordingly, all such modifications are intended to be included within the scope of the present inventions. Other substitutions, modifications, changes and omissions may be made in the design, variations in the arrangement or sequence of process/method steps, operating conditions and arrangement of the preferred and other exemplary embodiments without departing from the spirit of the present inventions.

In the description, reference is made to the accompanying drawings, which form a part of the specification. In the drawings, similar symbols typically identify similar components, unless context dictates otherwise. The illustrative embodiments described in the description, drawings, and claims are not meant to be limiting. Other embodiments may be utilized, and other changes may be made, without departing from the spirit or scope of the subject matter presented in the application.

While various aspects and embodiments have been disclosed in the application, other aspects and embodiments will be apparent to those skilled in the art. The various aspects and embodiments disclosed in the application are for purposes of illustration and are not intended to be limiting, with the true scope and spirit being indicated by the claims as presented and/or amended.

### TABLES

TABLE 1

| | PERCENT |
|---|---|
| INGREDIENT | (APPROX.) |
| Bread flour | 100.0 |
| Water | 70.0 |
| Instant yeast | 0.3 |
| Salt | 1.0-2.0 |

TABLE 2

| | PERCENT |
|---|---|
| INGREDIENT | (APPROX.) |
| Bread flour | 100.0 |
| Egg | 40.0 |
| Butter | 22.0 |
| Sugar | 20.0 |
| Milk | 14.0 |
| Water | 13.0 |
| Salt | 1.0-2.0 |
| Yeast | 1.0 |

TABLE 3

| | | AMOUNT | INTENDED OR DESIRED |
|---|---|---|---|
| TYPE | ADDITIVE | (approximate unit percent) | EFFECT |
| Proteins | Gluten | 3-10% of flour (depends | Strengthens dough |
| | | on type of flour) | |
| | Bean flour (fava, | Fava 0-0.2% of flour | Strengthens flour |
| | soybean, etc.) | Soybean 0.2-0.3% of flour | |
| | Whey | to suit | Minor addition of protein; |
| | | | strengthens dough; sugars help |
| | | | browning |
| Enzymes | Transglutaminase | 1% (iterate) | Larger holes; increased volume up to |
| | | | certain concentration; reduces |
| | | | allergenicity of gluten |
| | Amylase (malt) | 1-10% of flour | Breaks down starch to sugars; |
| | | | increased caramelization |
| | Fungal α-amylase | to suit | Sugar for caramelization and feeding |
| | | | yeast; breaks down starch; |
| | | | degades/softens gluten; useful for |
| | | | producing liquid doughs (crackers, |
| | | | flatbreads) |
| | Protease | to suit | Reduce mixing time (protease) |
| Yeast | Non-rising yeast | to suit | |
| | Inactive yeast | to suit | Add flavor |
| Gums | Guar gum | up to 1% | Tolerance to over mixing; increased |
| | | | water absorption; stronger dough |
| | | | (more resistant to mixing) |
| | Xanthan | 0.1-0.5% | Better crumb structure |
| | Carboxylmethyl | 0.1-0.5% | increase bread volume |
| | cellulose | | |
| | Locust bean gum | to suit | Extend shelf-life |
| | Alginate | 0.1-0.5% | Anti-staling agent; affects crumb |
| | | | hardness, staling time; increases |
| | | | dough volume |
| | κ-Carrageenan | 0.1-0.5% | |
| Acids | Ascorbic acid | 20-80 mg/kg flour (max | Improves dough strength; increase |
| | (Vitamin C) | 300 mg/kg flour) | loaf volume (e.g. ~20%); decreases |
| | | | length of fermentation, with possibly |
| | | | less organic acid formation and less |
| | | | flavor; oxidation |
| | Lecithin | 0.1-1.0% of flour | Reduces dough stickiness |
| | L-Cysteine | 0.1% | Improves dough extensibility |
| | Citric acid | 0.5% of flour | Less sticky dough |
| Other | Oxygen | to suit | Bleaches dough |
| | Potassium bromate | to suit | Strengthens dough; increases dough |
| | | | volume |
| | Potassium iodate | to suit | Oxiding agent |
| | Azodiacarbonamide | to suit | Oxiding agent |
| | Datem | 0.375-0.5% | Strengthen gluten network |

1-134. (canceled)

135. A composition having a pre-selected form comprising:
(a) a dough base formed from a first dough component, the first dough component is formulated from a first set of ingredients into a pre-selected form; and
(b) a distinct cavity within the dough base formed by a cavity-forming operation.

136. The composition of claim 135 wherein the composition is baked into a molded baked bread product.

137. The composition of claim 135 further comprising a fill material within the cavity.

138. The composition of claim 137 wherein the fill material includes a second dough component.

139. The composition of claim 138 wherein the second dough component comprises a second set of ingredients.

140. The composition of claim 139 comprising a multi-component dough product wherein the cavity in the first dough component is filled with the second dough component.

141. The composition of claim 135 wherein the cavity-forming operation includes a blow-molding operation.

142. The composition of claim 135 wherein the cavity-forming operation includes an injection molding operation.

143. The composition of claim 135 wherein the cavity-forming operation includes a fluid injected into the cavity.

144. The composition of claim 143 wherein the fluid includes a fill material.

145. The composition of claim 143 wherein the fluid includes a gas.

146. The composition of claim 143 wherein the fluid is within an inflatable balloon.

147. The composition of claim 135 wherein the cavity-forming operation comprises the insertion of a tool into the dough base.

148. The composition of claim 1 wherein the cavity-forming operation comprises the application of heat to the first dough component adjacent to the cavity in the base to gelatinize starch in the first dough component as to at least partially rigidify the interior of the cavity.

149. The composition of claim 135 further including a frozen material provided adjacent the interior wall of the cavity.

150. The composition of claim 135 wherein the cavity includes two or more cavities.

151. A process for producing a bread product having at least one distinct cavity comprising:
(a) mixing a first set of ingredients into a first dough component;
(b) forming the first dough component into a dough base in a fixture in a molding operation;
(c) forming a distinct cavity in the base with a cavity-forming operation; and
(d) finishing the bread product, wherein the finished bread product includes a finished distinct cavity.

152. The process of claim 151 wherein the steps of forming the base and forming the cavity in the base are performed at least partially simultaneously in the fixture.

153. The process of claim 151 wherein finishing the bread product comprises baking the bread product into a baked bread product.

154. The process of claim 151 wherein finishing the bread product comprises par-baking the bread product.

155. The process of claim 151 wherein finishing the bread product comprises freezing the bread product.

156. The process of claim 151 wherein the step of forming the dough base comprises an injection molding operation.

157. The process of claim 151 wherein the molding operation comprises blow-molding.

158. The process of claim 151 wherein the molding operation comprises a blow-molding operation in which the dough base is formed simultaneously with the cavity.

159. The process of claim 158 further comprising the step of filling the cavity.

160. The process of claim 158 wherein the steps of forming the cavity and filling the cavity with a second dough component are performed at least partially simultaneously.

161. A system for producing a bread product having a distinct cavity comprising:
(a) a mixing station for mixing a first set of ingredients into a first dough component;
(b) a forming station for forming the first dough component into a dough base having a form and a distinct cavity formed by a cavity-forming operation; and
(c) a dough finishing station for finishing the bread product into a finished bread product, the finished bread product at least partially retaining the cavity.

162. The system of claim 161 wherein the cavity-forming operation comprises the insertion of at least one of a tool or a fluid into the dough base.

163. The system of claim 161 wherein the mixing station is configured to mix a second set of ingredients into a fill material for the cavity.

164. The system of claim 161 wherein the forming station performs a dispensing operation of the first dough component to form the base.

165. The system of claim 161 wherein the forming station performs a cavity-forming operation on the first dough component of the base.

166. The system of claim 161 wherein the mixing station is configured to mix the first set of ingredients and at least one improver into a first dough component.

167. The system of claim 161 wherein the forming station includes a fixture configured to form the first dough component into a base.

168. The system of claim 161 wherein the forming station includes a mold fixture.

169. The system of claim 161 wherein the forming station includes a blow-molding machine.

170. The system of claim 161 wherein the forming station includes an injection molding machine.

171. The system of claim 161 wherein the forming station includes an extruding machine.

172. The system of claim 161 wherein the forming station includes an inlet for a tool.

173. The system of claim 161 wherein the finishing station includes a freezer.

174. The system of claim 168 wherein the bread component is formed to a shape of an interior cavity of the mold fixture.

175. The system of claim 168 wherein the mold fixture has a cavity with a shape and the bread product is formed to the shape.

176. The system of claim 168 wherein the mold fixture has an embossment transferred to the exterior surface of the bread product.
